(19) United States
(12) Patent Application Publication
(10) Pub. No.: US 2025/0033947 A1
(43) Pub. Date: Jan. 30, 2025

(54) CARBONATION PACKET, BEVERAGE CARBONATION SYSTEM AND METHOD OF CARBONATING A BEVERAGE

(71) Applicant: BONNE O INC., Toronto (CA)

(72) Inventor: Darren Hatherell, Toronto (CA)

(21) Appl. No.: 18/917,073

(22) Filed: Oct. 16, 2024

Related U.S. Application Data
(63) Continuation of application No. PCT/CA2023/050515, filed on Apr. 17, 2023.
(60) Provisional application No. 63/332,955, filed on Apr. 20, 2022.

(51) Int. Cl. B67D 1/00; F17C 1/00

(52) U.S. Cl. CPC B67D 1/0069; F17C 1/00; F17C 2221/03

(57) ABSTRACT

Carbonation packets, beverage carbonation systems, and methods of generating carbon dioxide gas for a beverage are disclosed. The carbonation packet comprises a packet body defining a single compartment, a granular carbonate material sealed within the single compartment, a granular acid material sealed within the single compartment, and a granular desiccant material sealed within the single compartment. The granular desiccant material prevents the granular carbonate material from reacting with the granular acid material while sealed in the single compartment. Each of the granular carbonate material, the granular acid material and the granular desiccant material are water-dissolvable.

### FIELD

This application relates to the field of beverage carbonation systems, beverage carbonators, and methods of carbonating a beverage.

### INTRODUCTION

Carbonated beverages such as, for example, sodas and sparkling water are popular with consumers. Many carbonated beverages are prepared at a factory and shipped to stores, where consumers travel to purchase them. Each of the preparation, shipping, and travel may contribute to a higher cost per beverage for the consumer. Further, the selection of carbonated beverages at retail is limited. Accordingly, it may be desirable to have a beverage carbonation system usable by a consumer in his/her home, for example. This may also be more convenient for a consumer.

### SUMMARY

The following is intended to introduce the reader to the detailed description that follows and not to define or limit the claimed subject matter.

In one aspect, a carbonation packet for depositing carbon dioxide generating material into a carbonation chamber of a beverage carbonator is disclosed. The carbonation packet comprises a packet body defining a single compartment, a granular carbonate material sealed within the single compartment, a granular acid material sealed within the single compartment, and a granular desiccant material sealed within the single compartment. The granular desiccant material prevents the granular carbonate material from reacting with the granular acid material while sealed in the single compartment. Each of the granular carbonate material, the granular acid material, the granular desiccant material is water-dissolvable.

In another aspect, a beverage carbonation system is disclosed. The beverage carbonation system comprises a carbonation packet and a beverage carbonator. The carbonation packet comprises a packet body defining a single compartment, a granular carbonate material sealed within the single compartment, a granular acid material sealed within the single compartment, and a granular desiccant material sealed within the single compartment. Each of the granular carbonate material, the granular acid material, the granular desiccant material is water-dissolvable. The granular carbonate material is reactive with the granular acid material in water to generate carbon dioxide gas. The single compartment is at least partially openable to release the granular carbonate material, the granular acid material, and the granular desiccant material therefrom. The beverage carbonator comprises a carbonation chamber having a carbonation source inlet, a fluid inlet, a gas outlet, and a carbonation source carrier. The carbonation source carrier is positioned to receive the granular carbonate material, the granular acid material and the granular desiccant material deposited into the carbonation chamber through the carbonation source inlet. The carbonation source carrier and the fluid inlet are arranged to expose the granular carbonate material, the granular acid material and the granular desiccant material to water introduced into the carbonation chamber through the fluid inlet.

In another aspect, a beverage carbonation system is disclosed. The beverage carbonation system comprises a carbonation packet and a beverage carbonator. The carbonation packet comprises a packet body defining a single compartment, a granular carbonate material sealed within the single compartment, a granular acid material sealed within the single compartment, and a granular desiccant material sealed within the single compartment. Each of the granular carbonate material, the granular acid material, the granular desiccant material is water-dissolvable. The granular carbonate material is reactive with the granular acid material in water to generate carbon dioxide gas. The packet body is flexible and rapidly water-dissolvable. The beverage carbonator comprises a carbonation chamber having a carbonation source inlet, a fluid inlet, a gas outlet, and a carbonation source carrier. The carbonation source carrier is positioned to receive the carbonation packet deposited into the carbonation chamber through the carbonation source inlet. The carbonation source carrier and the fluid inlet are arranged to expose the carbonation packet to water introduced into the carbonation chamber through the fluid inlet.

In another aspect, a method of generating carbon dioxide gas for a beverage is disclosed. The method involves: simultaneously receiving a granular carbonate material, a granular acid material and a granular desiccant material by a carbonation chamber; receiving a volume of water into the carbonation chamber, the received volume of water exceeding a water retention capacity of the granular desiccant material; and generating carbon dioxide gas from a reaction between at least the granular carbonate material and the granular acid material.

Other aspects and features of the teachings disclosed herein will become apparent to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a perspective view of an example beverage carbonator;

FIG. 2 is a perspective view of an example beverage carbonation system, including the beverage carbonator of FIG. 1 and a beverage container;

FIG. 3 is a cross-sectional view taken along line 3-3 of FIG. 2, with the beverage container disengaged with the beverage carbonator;

FIG. 4 is a cross-sectional view taken along line 4-4 of FIG. 2, with the beverage container engaged with the beverage carbonator;

FIG. 5 is a schematic illustration of an example electronic control device of the beverage carbonator of FIG. 1 shown communicatively coupled to a portable electronic device and a server computer;

FIGS. 6A-6B are perspective and top views of an example carbonation packet, respectively;

FIG. 6C is a cross-sectional view taken along line 6C-6C of FIG. 6A;

FIG. 6D is an enlarged view of the region shown in circle 6D of FIG. 6C;

FIG. 7A is a perspective view of another example carbonation packet;

FIG. 7B is a cross-sectional view taken along line 7B-7B of FIG. 7A;

FIG. 7C is an enlarged view of the region shown in circle 7C of FIG. 7B;

FIG. 8 is a front view of an example retail package that comprises a number of the carbonation packets of FIGS. 6A-6D;

FIG. 9 is a schematic illustration of the beverage carbonation system of FIG. 2, in a container connected state;

FIG. 10 is a schematic illustration of the beverage carbonation system of FIG. 2, in a reservoir draw state;

FIG. 11 is a schematic illustration of the beverage carbonation system of FIG. 2, in a gas recirculation state;

FIG. 12 is a schematic illustration of the beverage carbonation system of FIG. 2, in a container sealed state;

FIG. 13 is a perspective view of a carbonation chamber of the beverage carbonator of FIG. 1;

FIG. 14 is a cross-sectional view taken along line 14-14 of FIG. 13;

FIG. 15 is a flowchart of an example method of generating carbon dioxide gas for a beverage;

FIG. 16 is a partial cross-sectional view taken along line 3-3 of FIG. 2, with a container engagement actuator in a disengaged position;

FIG. 17 is the partial cross-sectional view of FIG. 16, with the carbonation packet of FIGS. 6A-6D deposited into the carbonation chamber;

FIG. 18 is the partial cross-sectional view of FIG. 16, with the container engagement actuator in an engaged position;

FIG. 19 is the partial cross-sectional view of FIG. 16, with the container engagement actuator in the engaged position and water pooling in the carbonation chamber;

FIG. 20 is the partial cross-sectional view of FIG. 16, with the container engagement actuator in the engaged position, and carbon dioxide gas recirculating through the carbonation chamber;

FIG. 21 is the partial cross-sectional view of FIG. 16, with the container engagement actuator in the engaged position, and gas recirculation terminated;

FIG. 22 is the partial cross-sectional view of FIG. 16, with the container engagement actuator in the disengaged position, and the carbonation chamber emptied of disposable liquid byproduct;

FIG. 23 is a side-elevation view of an engagement actuator and carbonation chamber of the beverage carbonator of FIG. 1, with the engagement actuator in a disengaged position and exterior door opened;

FIG. 24 is the side elevation view of FIG. 23, with the engagement actuator in an engaged position and exterior door closed;

FIG. 25 is a pressure curve of system gas pressure during a carbonation operation;

FIG. 26 is a cross-sectional of an example carbonation chamber that may be used in the beverage carbonator of FIG. 1.

FIG. 27 is a perspective view of a carbonation source carrier of the carbonation chamber of FIG. 26;

FIG. 28 is an upper cutaway view of the carbonation source carrier of the carbonation chamber of FIG. 26, with quarter section 28-28 of FIG. 27 cut away;

FIG. 29 is a lower cutaway view of the carbonation source carrier of the carbonation chamber of FIG. 26, with quarter section 28-28 of FIG. 20 cut away;

FIG. 30 is a partial cross-sectional view taken along line 3-3 of FIG. 2, with a container engagement actuator in a disengaged position;

FIG. 31 is the partial cross-sectional view of FIG. 30, with carbon dioxide generating material received into the carbonation chamber;

FIG. 32 is the partial cross-sectional view of FIG. 30, with the container engagement actuator in an engaged position;

FIG. 33 is the partial cross-sectional view of FIG. 30, with the container engagement actuator in the engaged position and water pooling in the carbonation chamber;

FIG. 34 is the partial cross-sectional view of FIG. 30, with the container engagement actuator in the engaged position, and carbon dioxide gas production underway;

FIG. 35 is the partial cross-sectional view of FIG. 30, with the container engagement actuator in the engaged position, and carbon dioxide gas recirculating through the carbonation chamber;

FIG. 36 is the partial cross-sectional view of FIG. 30, with the container engagement actuator in the engaged position, and gas recirculation terminated;

FIG. 37 is the partial cross-sectional view of FIG. 30, with the container engagement actuator in the disengaged position, and byproduct waste evacuated from the carbonation chamber;

FIGS. 38A-38B are top and side views of an example carbonation packet with separated compartments for granular carbonate material and granular acid material;

FIG. 39A is a perspective view of another example carbonation packet with separated compartments for granular carbonate material and granular acid material; and

FIG. 39B is a cross-sectional view taken along 39B-39B of FIG. 39A.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

As used herein and in the claims, a first element is said to be ‘communicatively coupled to’ or ‘communicatively connected to’ or ‘connected in communication with’ a second element where the first element is configured to send or receive electronic signals (e.g., data) to or from the second element, and the second element is configured to receive or send the electronic signals from or to the first element. The communication may be wired (e.g., the first and second elements are connected by one or more data cables), or wireless (e.g., at least one of the first and second elements has a wireless transmitter, and at least the other of the first and second elements has a wireless receiver). The electronic signals may be analog or digital. The communication may be one-way or two-way. In some cases, the communication may conform to one or more standard protocols (e.g., SPI, I²C, Bluetooth™, or IEEE™ 802.11).

As used herein and in the claims, two components are said to be “fluidly connected” or “fluidly coupled” where the two components are positioned along a common fluid flow path. “Fluid” refers to liquid and/or gas. The fluid connection may be formed in any manner that can transfer fluids between the two components, such as by a fluid conduit which may be formed as a pipe, hose, channel, or bored passageway. One or more other components can be positioned between the two fluidly coupled components. Two components described as being “downstream” or “upstream” of one another, are by implication fluidly connected.

As used herein and in the claims, a group of elements are said to ‘collectively’ perform an act where that act is performed by any one of the elements in the group, or performed cooperatively by two or more (or all) elements in the group.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

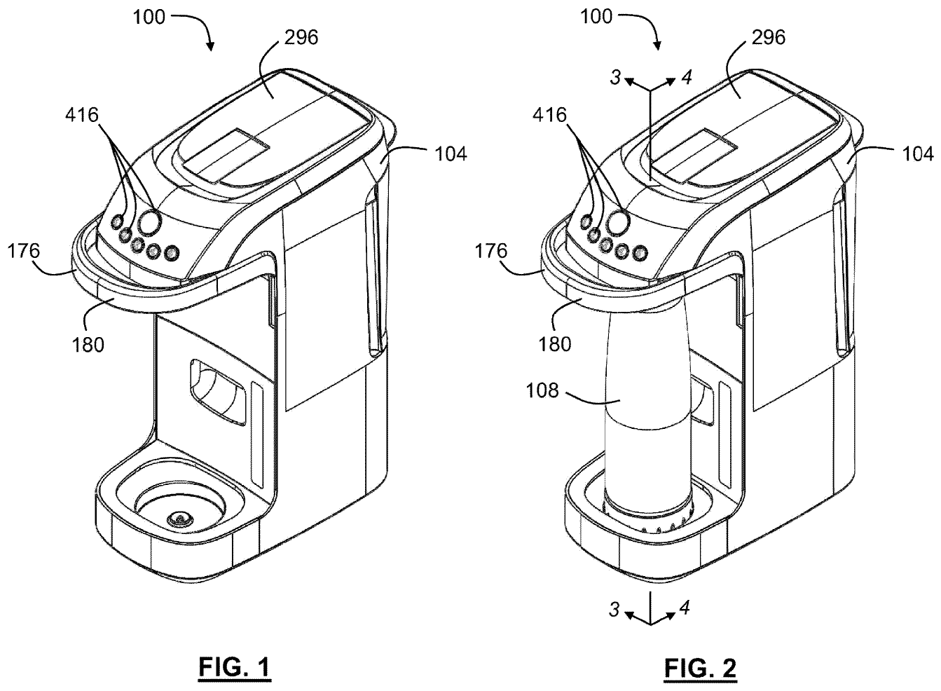

Reference is first made to FIGS. 1-4. Examples herein relate to a beverage carbonation system, referred to generally as 100. As shown, beverage carbonation system 100 comprises a beverage carbonator 104 and a beverage container 108. In use, the beverage container 108 can be filled with a liquid beverage (e.g., water, juice, wine, etc.), the beverage container 108 connected to the beverage carbonator 104, and the beverage carbonator 104 activated to carbonate the beverage. In the result, the beverage container 108 holds a carbonated liquid beverage.

The beverage carbonation system 100 may carbonate the beverage in-situ within the beverage container 108. That is, the beverage may at all times remain in the beverage container 108 from the time the beverage container 108 is connected to the beverage carbonator 104 until the beverage container 108 is removed from the beverage carbonator 104. When compared to a system that moves the beverage into the beverage carbonator, this can avoid the beverage spoiling a fluid flow path in the beverage carbonator. For example, a juice or sugary drink beverage can form a sticky residue within the fluid flow path when dried. In some cases, such spoiling can cause damage to the beverage carbonator, contaminate subsequently carbonated beverages, and/or require time consuming maintenance (e.g., flushing the beverage carbonator with a cleaning agent).

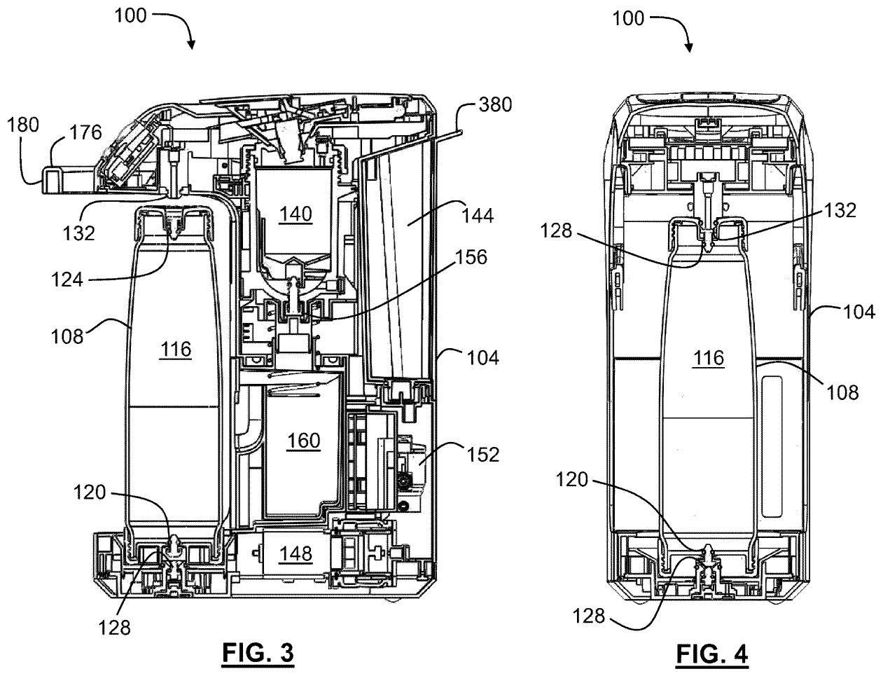

Referring to FIGS. 3-4, beverage container 108 (e.g., a bottle) comprises an inner volume 116, a container inlet 120 to admit gas (e.g., carbon dioxide gas) into inner volume 116, and a container outlet 124 to discharge gas (e.g., carbon dioxide gas) from inner volume 116. As shown in FIG. 3, beverage carbonator 104 comprises a carbonation chamber 140 where carbon dioxide gas is generated. As will be described below, carbonation chamber 140 is fluidly coupled to the beverage container 108 when the beverage container 108 is engaged with the beverage carbonator 104. This allows carbon dioxide gas generated in the carbonation chamber 140 to flow into the beverage container 108 and thereby carbonate the beverage within the beverage container 108. In some examples, inner volume 116 of beverage container 108 is between 250 mL to 2 L, such as for example 500 ml to 1 L.

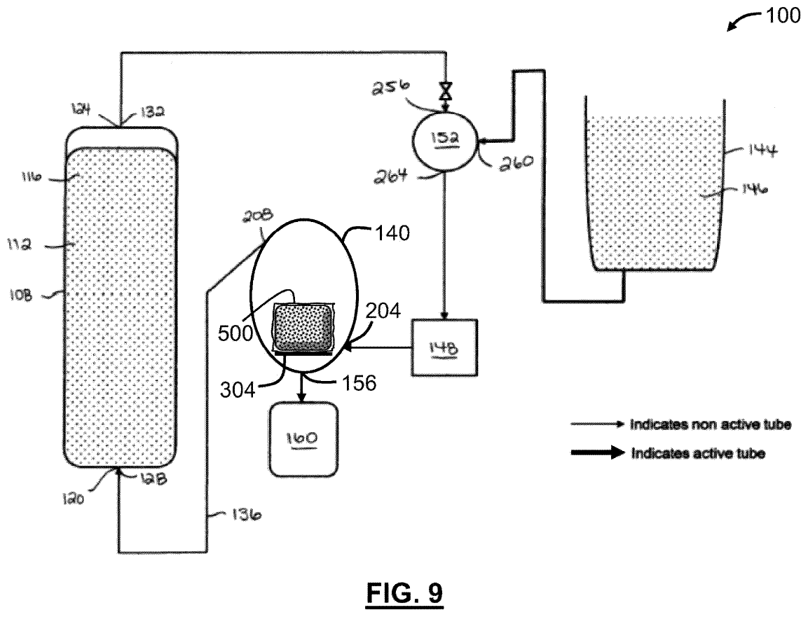

In the example shown, beverage carbonator 104 comprises a carbonator outlet 128 to discharge carbon dioxide gas generated in the carbonation chamber 140 into container inlet 120, and a carbonator inlet 132 to receive carbon dioxide gas from container outlet 124 into beverage carbonator 104. Although hidden from view in FIGS. 3-4, a carbonator fluid flow path 136 (FIG. 9) extends between carbonator inlet 132 and carbonator outlet 128 so that carbon dioxide gas received from container outlet 124 can be recirculated back into the beverage container 108 at container inlet 120. In an alternative example, beverage carbonator 104 may not comprise a carbonation inlet 132. In such an example, container outlet 124 may act to vent unabsorbed carbon dioxide gas from inner volume 116 into the surrounding environment.

In the example shown, beverage carbonator 104 comprises a water reservoir 144 for supplying water to carbonation chamber 140, and a pump 148 that acts to move water from water reservoir 144 into carbonation chamber 140. Pump 148 may also act to recirculate carbon dioxide gas from carbonator inlet 132 to carbonator outlet 128. In an alternative example, beverage carbonator 104 may not require a pump 148 to move water from water reservoir 144 into carbonation chamber 140. For example, water reservoir 144 may be positioned above carbonation chamber 140 so that water may be moved by gravity (i.e., gravity-fed) from water reservoir 144 into carbonator chamber 140. In another alternative example, beverage carbonator 104 may not comprise a water reservoir 144 and/or a pump 148. In this example, carbonation chamber 140 may receive water from a building's water supply (e.g., a water line may connect carbonation chamber 140 to the building's water supply).

In the example shown, beverage carbonator 104 also comprises a flow valve 152 to fluidly connect pump 148 to water reservoir 144 or to carbonator inlet 132 in different system states. Flow valve 152 may comprise electronics and electro-mechanical compartments. For example, flow valve 152 may comprise a processor (e.g., a microcontroller) that toggles the state of one or more solenoids in response to determining that pressure readings from one or more pressure sensors indicate a system gas pressure which exceeds the predetermined threshold. An advantage of this design is that the processor can be reprogrammed with a different predetermined threshold, e.g., based on a selected user mode of operation (e.g., carbonation level). In an alternative example, flow valve 152 may be mechanical. That is, mechanical flow valve 152 may operate to toggle fluid connections to pump 148 in response to system gas pressure, as described above, without electronics or electro-mechanical components. In some examples, flow valve 152 can comprise features of the flow valves disclosed in U.S. Patent Publication No. 2020/0156019 A1, the entire contents of which is hereby incorporated herein by reference.

In an alternative example, beverage carbonator 104 may not comprise such a flow valve 152. For example, beverage carbonator 104 may comprise a first dedicated pump that acts to move water from water reservoir 144 into carbonation chamber 140 and a second dedicated pump that acts to recirculate carbon dioxide gas from carbonator inlet 132 to carbonator outlet 128.

Carbonation chamber 140 is shown having a byproduct outlet 156 to discharge byproduct waste from carbonation chamber 140 into an emptyable (e.g., removable) byproduct waste container 160. Byproduct waste container 160 may be emptied periodically as needed (e.g., by dumping byproduct waste into a sink).

Referring again to FIGS. 1-2, beverage carbonator 104 comprises a container engagement actuator 176. In the example shown, container engagement actuator 176 may comprise a manually user-operable lever 180 that is movable (e.g., rotatable) to engage and disengage beverage container 108 from beverage carbonator 104. FIG. 3 shows container engagement actuator 176 in a container disengaged position (e.g., lever 180 is fully raised). When the engagement actuator 176 is in the container disengaged position, beverage container inlet 120 and carbonator outlet 128 are unsealed, and container outlet 124 and carbonator inlet 132 are unsealed. Accordingly, when the container engagement actuator 176 is in the container disengaged position, beverage container 108 may be disconnected (i.e., removed) from beverage carbonator 104.

By moving container engagement member 176 (e.g., lowering lever 180), a user can engage the beverage container 108 with the beverage carbonator 104. With reference to FIGS. 4 and 24, when the engagement actuator 176 is in a container engaged position (e.g., lever 180 is fully lowered), beverage container inlet 120 and carbonator outlet 128 are fluidly coupled, and container outlet 124 and carbonator inlet 132 are fluidly coupled. Container inlet and outlet 120, 124 and carbonator outlet and inlet 128, 132 may be fluidly connected in any manner that allows container inlet and outlet 120, 124 to reclose to seal container inner volume 116.

Due to the fluid connection between container inlet 120 and carbonation outlet 128, carbon dioxide gas generated in carbonation chamber 140 may flow into beverage container 108 at container inlet 120. Further, due to the fluid connection between container outlet 124 and carbonation inlet 132, any carbon dioxide gas that passes through the beverage container 108 without being absorbed into the beverage may pass back into beverage carbonator 104 at carbonator inlet 132. As discussed above, this carbon dioxide gas can be recirculated along fluid flow path 136 (FIG. 9) back into beverage container 108 at container inlet 120. This allows a volume of carbon dioxide gas generated by beverage carbonator 104 to make repeated contact with the beverage inside beverage container 108, and thereby accelerate absorption into the beverage as compared with relying on the diffusion of carbon dioxide gas, which has accumulated in the container headspace, into the liquid below. Consequently, beverage carbonation system 100 may take less time to carbonate a beverage, all else being equal.

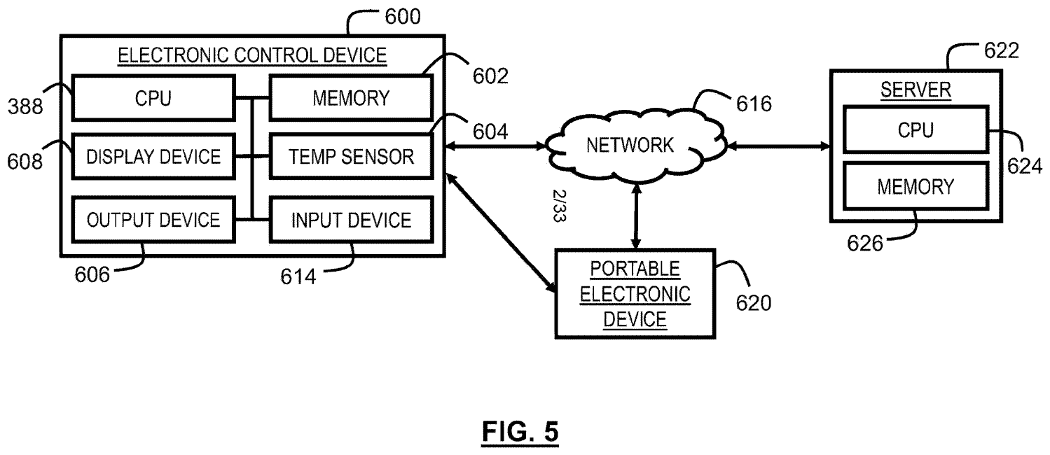

In some examples, beverage carbonator 104 comprises an electronic control device with an electronic controller 388 (also referred to as “processor 388”) (FIG. 5). The electronic control device may comprise one or more inputs (e.g., user inputs) and outputs (e.g., valves, relays, switches, or pumps) that are communicatively coupled to electronic controller 388 and operated by control signals from electronic controller 388. For example, electronic controller 388 may determine the timing of events (e.g., activation of flow valve 152 and pump 148) based on a carbonation program stored in memory. In some cases, electronic controller 388 is responsive to inputs from, e.g., user inputs 416 (FIGS. 1-2). For example, a user may manipulate user inputs 416 to direct the operation of electronic controller 388 (e.g., to select a carbonation level, start a carbonation operation, or stop a carbonation operation).

Reference is made to FIG. 5, which shows a schematic illustration of an example electronic control device 600 of beverage carbonator 104. As shown, electronic control device 600 may comprise a connection with a network 616 such as a wired or wireless connection to the Internet or to a private network. In some cases, network 616 comprises other types of computer or telecommunication networks.

The schematic of FIG. 5 illustrates the connection of electronic control device 600 to a portable electronic device 620. As shown, portable electronic device 620 can be communicatively connected to electronic control device 600 through a wireless network 616 (e.g., wireless access network, Bluetooth®, etc.) and/or through a wired connection (e.g., USB). These connections can allow electronic control device 600 of beverage carbonator 104 to communicate and/or relay signals with portable electronic device 620. Portable electronic device 620 may comprise a smart phone, tablet or notebook computer, for example.

In one example, a user may be able to control operation of beverage carbonator 104 (e.g., start or stop a carbonation operation, select a carbonation level, etc.) by accessing a website or running a program on portable electronic device 620. For example, portable electronic device 620 may send control signals to electronic controller 388, and in response, electronic controller 388 may activate pump 148 and/or flow valve 152 in accordance with those control signals.

In the example shown, electronic control device 600 comprises a processor 388, a memory 602, a temperature sensor 604, an output device 606, a display device 608, and an input device 614. Each of memory 602, temperature sensor 604, output device 606, display device 608, and input device 614 are communicatively coupled to processor 388, directly or indirectly. In some examples, electronic control device 600 comprises multiple of any one or more of processor 388, memory 602, temperature sensor 604, output device 606, display device 608, and input device 614. In some examples, electronic control device 600 does not comprise one or more of temperature sensor 604, network connections, output devices 606, display devices 608, and input devices 614. For example, electronic control device 600 may not comprise temperature sensor 604, and/or may not comprise output device 606, and/or may not comprise display device 608, and/or may not comprise input device 614.

In some examples, electronic control device 600 is a single, unitary device that houses all of its subcomponents (processor 388, memory 602, etc.). In other examples, electronic control device 600 is composed of two or more discrete subdevices that are communicatively coupled to each other, that collectively comprise all of the subcomponents of electronic control device 600 (processor 388, memory 602, temperature sensor 604, etc.), and that collectively provide the functionality described herein.

Memory 602 can comprise random access memory (RAM), read only memory (ROM), or similar types of memory. Also, in some examples, memory 602 stores one or more applications for execution by processor 388. Applications correspond with software modules including computer executable instructions to perform processing for the functions and methods described below (e.g., one or more carbonation programs). In some examples, some or all of memory 602 may be integrated with processor 388. For example, processor 388 may be a microcontroller (e.g., Microchip™ AVR, Microchip™ PIC, or ARM™ microcontroller) with onboard volatile and/or non-volatile memory.

Generally, processor 388 can execute computer readable instructions (also referred to as applications or programs). The computer readable instructions can be stored in memory 602 or can be received from remote storage accessible through network 616, for example. When executed, the computer readable instructions can configure processor 388 (or multiple processors 388, collectively) to perform the acts described herein with reference to beverage carbonator 104, for example.

Temperature sensor 604 can comprise features of the temperature sensors disclosed in International Patent Publication No. WO 2022/051839, the entire contents of which is hereby incorporated herein by reference. Temperature sensor 604 is configured to measure the temperature of the beverage held in beverage container 108 and communicate the measured temperature to processor 388. This allows processor 388 to take the temperature of the beverage into account when determining a carbonation duration (also referred to as a “carbonation cycle”). All else being equal, a beverage at a colder temperature (e.g., refrigerated water at 4° C.) will absorb carbon dioxide at a faster rate than the same beverage at a warmer temperature (e.g., cold tap water at 12° C.). As a result, the warmer beverage may need a longer carbonation duration (i.e., more contact time with the carbon dioxide gas) than the colder one to obtain the same carbonation level. Adjusting the carbonation duration for differences in beverage temperature can provide one or more advantages. For example, a user (i.e., drinker) may not have to worry that their cold beverage will be over carbonated, or alternatively, that their warm beverage will be under carbonated. In other words, the user may experience consistency in the carbonation level, irrespective of the temperature of the beverage being carbonated.

Output device 606 can comprise any device for outputting data, such as for example speakers. In some examples, output device 606 comprises one or more of output ports and wireless radios (e.g., Bluetooth®, or 802.11x) for making wired and/or wireless connections to external devices (e.g., for sending alerts, such as a carbonation complete notification or error notification to portable electronic device 620).

Display device 608 can comprise any type of device for presenting visual information. For example, display device 608 can be a computer monitor, a flat-screen display, or a display panel (e.g., OLED, LCD, or TFT display panel).

Input device 614 can comprise any device for entering information into electronic control device 600. Input device 614 can be a keyboard, keypad, button, switch, cursor-control device, touchscreen, camera, or microphone. For example, referring to FIGS. 1-2, input device 614 is shown as multiple user inputs 416 located on the front of beverage carbonator. Input device 614 can also comprise input ports and wireless radios (e.g., Bluetooth®, or 802.11x) for making wired and wireless connections to external devices (e.g., for sending control signals, such as user selections, to processor 388 from portable electronic device 620).

FIG. 5 illustrates one example hardware schematic of an electronic control device 600. In alternative examples, electronic control device 600 contains fewer, additional or different components. In addition, although aspects of an implementation of electronic control device 600 are described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM.

The schematic of FIG. 5 illustrates the connection of electronic control device 600 to a remote server computer 622 across network 616 (e.g., a wired or wireless access network, which may comprise a private network and/or a public network such as the internet). This connection can allow electronic control device 600 and server computer 622 to communicate and/or relay signals with each other. For simplicity of illustration, only one electronic control device 600 is shown connected to server computer 622. However, multiple electronic control devices 600 may be concurrently connected to server computer 622. Accordingly, server computer 622 can be communicatively coupled with multiple beverage carbonators 104 at a given time.

In the example shown, server computer 622 comprises a processor 624 and a memory 626. Memory 626 is communicatively coupled to processor 624, directly or indirectly. In some examples, server computer 622 comprises multiple of any one or both of processor 624 and memory 626. In some examples, server computer 622 is a single, unitary device that houses all of its subcomponents (processor 624 and memory 626). In other examples, server computer 622 is composed of two or more discrete subdevices that are communicatively coupled to each other, that collectively comprise all of the subcomponents of server computer 622 (processor 624 and memory 626), and that collectively provide the functionality described herein.

Memory 626 can comprise random access memory (RAM), read only memory (ROM), or similar types of memory. Also, in some examples, memory 626 stores one or more applications for execution by processor 624.

The schematic of FIG. 5 illustrates the connection of remote server computer 622 to a portable electronic device 620. As shown, portable electronic device 620 can be connected to electronic control device 600 through a wireless network 616 (e.g., wireless access network, Bluetooth®, etc.). Such a connection can allow processor 624 of server computer 622 to communicate and/or relay signals with portable electronic device 620.

In some examples, a user may be able to control operation of beverage carbonator 104 (e.g., start or stop a carbonation operation, select a carbonation level, etc.) via server computer 622. For example, portable electronic device 620 may send control signals to server computer 622, which in turn may relay the control signals to electronic controller 388 (or generate and send control signals to electronic controller 388), and in response, electronic controller 388 may activate pump 148 and/or flow valve 152 in accordance with those control signals.

In some examples, electronic control device 600 stores information in a remote storage device, such as memory 626 of remote server computer 622, accessible across a network, such as wireless network 616 or another suitable network. In other examples, electronic control device 600 stores information distributed across multiple storage devices, such as memory 602 and memory 626 (i.e., each of the multiple storage devices stores a portion of the information and collectively the multiple storage devices store all of the information). Accordingly, storing data on a storage device as used herein and in the claims, means storing that data in a local storage device, storing that data in a remote storage device, or storing that data distributed across multiple storage devices, each of which can be local or remote.

Generally, processor 624 can execute computer readable instructions (also referred to as applications or programs). In some examples, processor 388 of electronic control device 600 and processor 624 of server computer 622 are configured to collectively execute computer readable instructions. That is, when executed, the computer readable instructions can collectively configure processors 388, 624 to perform the acts described herein with reference to beverage carbonator 104, for example.

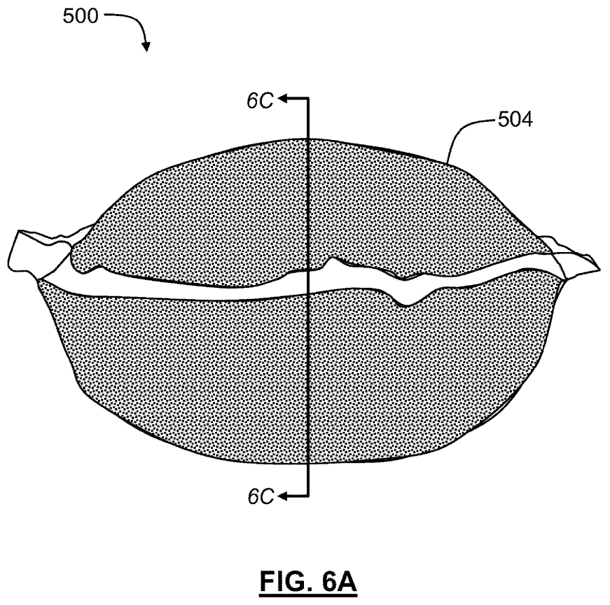

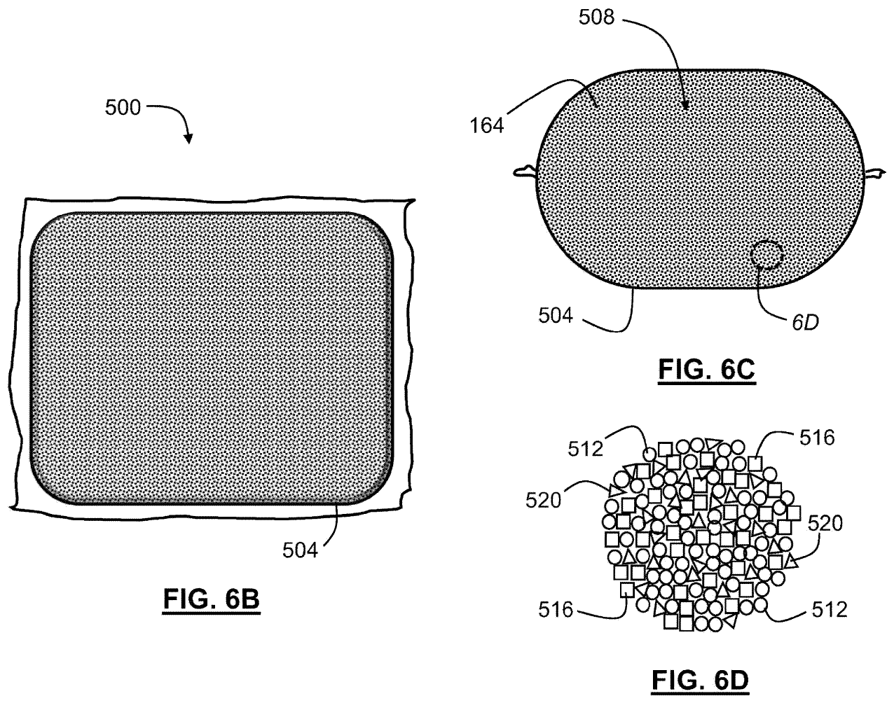

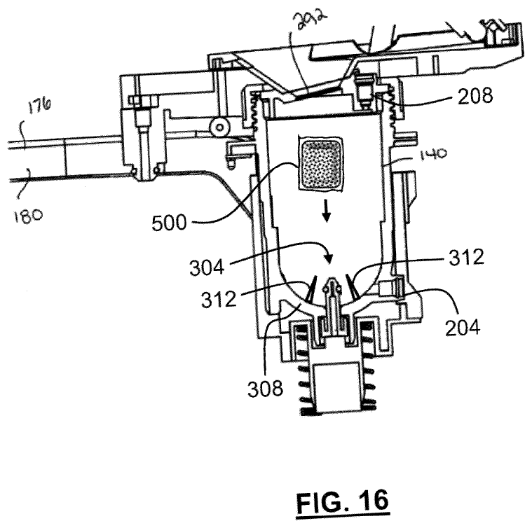

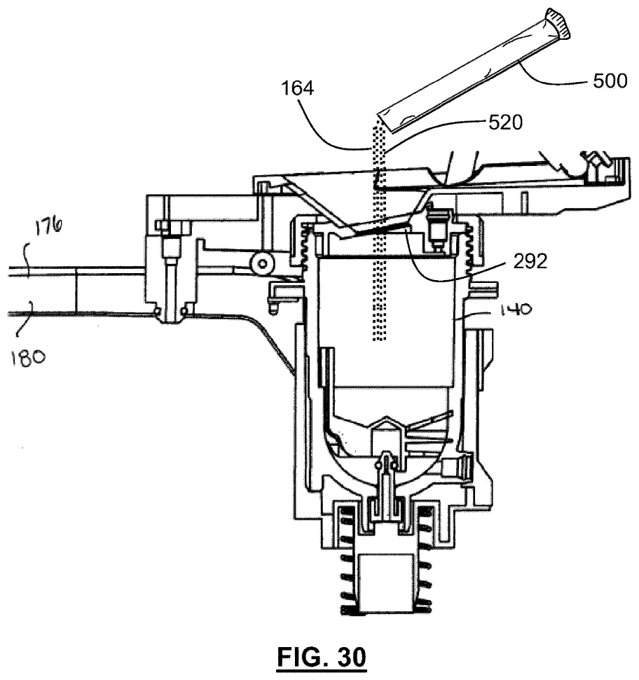

Reference is now made to FIGS. 6A-6D. Examples herein relate to a carbonation packet, referred to generally as 500. Carbonation packet 500 holds carbon dioxide generating material 164 that comprises at least two ingredients. The two ingredients may be any substances that, when combined form a carbon dioxide generating material, which in an aqueous mixture, reacts to produce carbon dioxide gas. In one example, to provide a source of carbon dioxide gas, the carbon dioxide generating material 164 held in carbonation packet 500 can be deposited (e.g., poured) into a carbonation chamber 140 (e.g., FIG. 30). In another example, to provide a source of carbon dioxide gas, the carbonation packet 500 itself can be deposited (e.g., dropped) into a carbonation chamber 140 (e.g., FIG. 16). Once the carbon dioxide generating material 164 has been deposited in carbonation chamber 140, beverage carbonator 104 (e.g., FIG. 3) can be activated to carbonate a beverage.

With reference to FIGS. 6A and 6C, the carbonation packet 500 comprises a packet body 504 that defines a single compartment 508. Carbon dioxide generating material 164 is shown held within the single compartment 508. Referring to FIG. 6D, the carbon dioxide generating material 164 comprises a granular carbonate material 512 and a granular acid material 516. Generally, granular carbonate material 512 and granular acid material 516 have several advantages, such as, for example, they are relatively inexpensive, non-toxic, easy to transport, and easy to handle, among other things. Each of the granular carbonate material 512 and the granular acid material 516 may be water-dissolvable.

Granular carbonate material 512 is reactive with granular acid material 516 when mixed in water to generate carbon dioxide gas. Exposure of granular carbonate material 512 to water (e.g., moisture), even while the granular carbonate material 512 is sealed within the single compartment 508, can cause the granular carbonate material 512 to prematurely react with the granular acid material 516. To prevent premature reaction between the granular carbonate material 512 and the granular acid material 516 (e.g., while carbonation packet 500 is still in retail packaging), a granular desiccant material 520 is sealed within the single compartment 508. Generally, the granular desiccant material 520 is relatively inexpensive, non-toxic, easy to transport, and easy to handle. The granular desiccant material 520 may be water-dissolvable.

Over time moisture (e.g., water vapor) can make its way inside the packet body 504 causing the granular carbonate material 512 and the granular acid material 516 held therein to prematurely react. For example, water vapor may enter while the carbonation packet 500 is in retail packaging and/or in storage at a user's home. Even small quantities of water can cause a premature reaction between the granular carbonate material 512 and the granular acid material 516. Keeping the carbonation packet(s) 500 in a humid climate can intensify the degree of premature reaction. It is for this reason that granular carbonate material 512 and granular acid material 516 are generally sealed in separated compartments. With the granular carbonate material 512 and the granular acid material 516 sealed in their own dedicated compartment, any moisture that enters is unable to cause a reaction between granular carbonate material 512 and granular acid material 516.

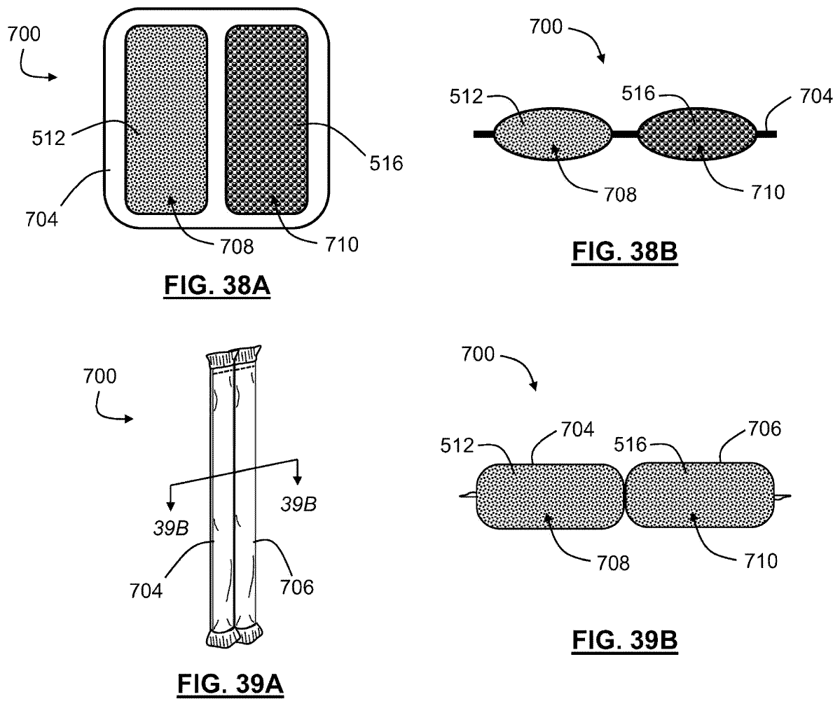

FIGS. 38A-38B show an example carbonation packet 700 in which the granular carbonate material 512 and the granular acid material 516 are held apart from one another. As shown, the packet body 704 defines two adjacent and separately sealed compartments 708 and 710. The granular carbonate material 512 is sealed within the first compartment 708, while the granular acid material 516 is sealed within the second compartment 710.

FIGS. 39A-39B show another example carbonation packet 700 in which the granular carbonate material 512 and the granular acid material 516 are held apart from one another. As shown, carbonation packet 700 comprises two packet bodies 704, 706. Each packet body 704, 706 defines a respective internal compartment 708, 710. The granular carbonate material 512 is sealed within compartment 708, while the granular acid material 516 is sealed within compartment 710. In some cases, the packet bodies 704, 706 may be connected by an elastic, glue, and/or another suitable type of adhesive. Connecting packet bodies 704, 706 in some manner may keep the granular acid material 512 with the corresponding granular acid material 516 (as both are needed to generate carbon dioxide gas).

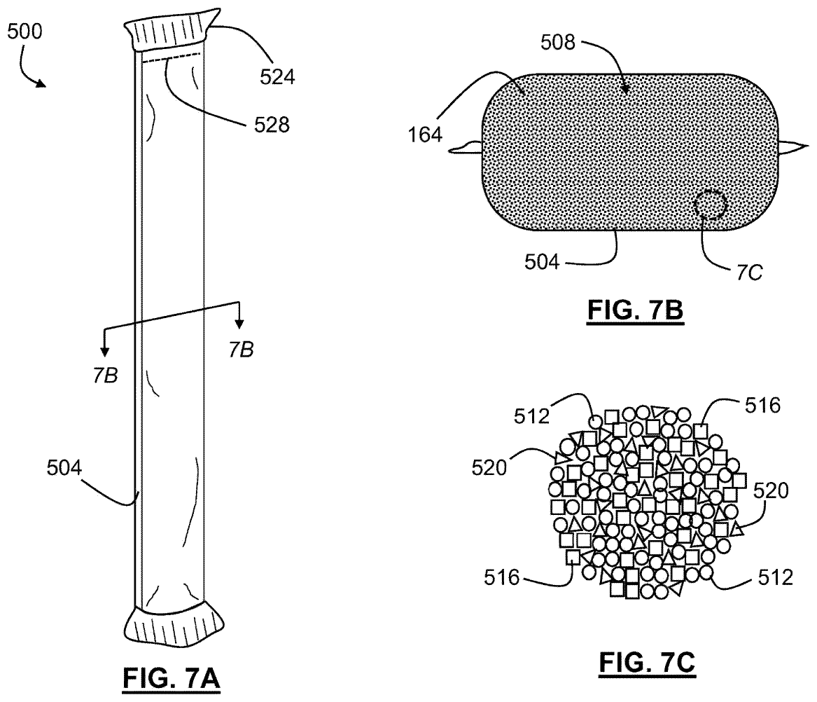

Sealing the granular carbonate material 512 and the granular acid material 516 in separated compartments 708, 710 presents one or more challenges. For example, it can make manufacturing the carbonation packet 700 more difficult, time consuming and/or expensive compared to a carbonation packet 500 in which the granular carbonate material 512 and the granular acid material 516 are held together in single compartment 508 (see e.g., FIGS. 6C-6D). It is generally easier to manufacture the carbonation packet 500 of FIGS. 6A-6D and FIGS. 7A-7C as the packet body 504 defines a single compartment 508.

Alternatively, or in addition, sealing the granular carbonate material 512 and the granular acid material 516 in separated compartments can be inconvenient from a user perspective. With the carbonation packet 700 of FIGS. 39A-39B, for example, the user must open two compartments 708, 710 to release the granular carbonate material 512 and the granular acid material 516 (e.g., tear or cut both packet bodies 704, 706). User convenience can be improved by sealing the granular carbonate material 512 and the granular acid material 516 together in a single compartment because the user only must open that one compartment.

As described above, to prevent premature reaction between the granular carbonate material 512 and the granular acid material 516, the granular desiccant material 520 is sealed within the single compartment 508. The granular desiccant material 520 can absorb moisture from air either by physical adsorption or by chemical reaction, and thus reduce the humidity in the headspace of sealed compartment 508. With reference to FIGS. 6C and 6D, the granular desiccant material 520 is shown interspersed with the granular carbonate material 512 and the granular acid material 516 within the single compartment 508 defined by packet body 504. The granular desiccant material 520 can keep the granular carbonate material 512 and the granular acid material 516 from reacting while sealed within the single compartment 508. The granular desiccant material 520 prevents the granular carbonate material 512 from reacting with the granular acid material 516 by absorbing water (e.g., water vapor) within the single compartment 508. In this way, the absorbed water is unavailable to initiate a reaction between the granular carbonate material 512 and the granular acid material 516.

Sealing the granular desiccant material 520 within the single compartment 508 along with the granular carbonate material 512 and the granular acid material 516 can extend the shelf life of the carbonation packet 500. As described above, the granular desiccant material 520 can absorb water within the single compartment 508 that would otherwise cause a premature reaction between the granular carbonate material 512 and the granular acid material 516. Premature reaction between the granular carbonate material 512 and the granular acid material 516 while sealed in the single compartment 508 may reduce their carbon dioxide generating capacity over time. In some cases, premature reaction may render the carbonation packet 500 unusable (e.g., the carbon dioxide generating capacity is reduced to a level insufficient to carbonate a beverage). The granular desiccant material 520 can keep the granular carbonate material 512 and the granular acid material 516 from reacting while sealed within the single compartment 508. Accordingly, it is not until at least a portion of the granular carbonate material 512 and granular acid material 516 are released (i.e., unsealed) from the single compartment 508 and mixed in water that a carbon dioxide generating reaction can occur.

The granular carbonate material 512, the granular acid material 516 and the granular desiccant material 520 can have any distribution within the single compartment 508 that allows the granular desiccant material to absorb (e.g., bind with) water. In one example, the granular desiccant material 520 may be positioned between the granular carbonate material 512 and the granular acid material 516. That is, the granular carbonate material 512 is at one side of the single compartment 508, the granular acid material 516 is at the opposed side, and the granular desiccant material 520 is provided between the granular carbonate material 512 and the granular acid material 516. The materials 512, 516 and 520 may be tightly packed within the single compartment 508 so that they maintain their relative positions. In this example, the granular desiccant material 520 may also act as a barrier between the granular carbonate 512 and the granular acid material 516 to further prevent premature reaction.

In the example shown in FIG. 6D, the granular carbonate material 512, the granular acid material 516 and the granular desiccant material 520 are mixed. Such a mixture may be beneficial as the granular desiccant material 520 is dispersed (e.g., spread out) within the single compartment 508. In some examples, the granular carbonate material 512, the granular acid material 516 and the granular desiccant material 520 may be homogenously mixed within the single compartment 508. In these examples, the composition of the granular carbonate material 512, the granular acid material 516 and the granular desiccant material 520 is generally uniform throughout the mixture.

An advantage of the “single compartment” configuration of carbonation packet 500 is that it allows the carbon dioxide generating material 164 to be put in a variety of packaging. Packet body 504 can have any suitable configuration for holding granular carbonate material 512, granular acid material 516, and granular desiccant material 520. As exemplified in FIG. 6A-6D, the carbonation packet 500 can comprise a dissolvable packet body 504, which is flexible and rapidly water-dissolvable. As used herein and in the claims, rapidly dissolvable means at least 50% dissolved when exposed to water for 15 minutes. By dissolving packet body 504 in water, the granular carbonate material 512, the granular acid material 516 and the granular desiccant material 520 can be released from the single compartment 508. In some examples, dissolvable packet body 504 is at least 50% dissolved when exposed to water for 5 minutes, such as for example 75% to 100% dissolved, such as approximately 90% to 100% dissolved.

The dissolvable packet body 504 may be formed of a water-soluble synthetic polymer, such as polyvinyl alcohol (PVA), thermoplastic polymers (e.g., polylactic acid), or cellulose esters (e.g., cellulose acetate or nitrocellulose). In some examples, the dissolvable packet body 504 is compostable and comprises polyhydroxyalkanoates (e.g., poly-3-hydroxybutyrate (PHB), polyhydroxyvalerate (PHV), or polyhydroxyhexanoate (PHH)), cellulose esters (e.g., cellulose acetate or nitrocellulose), or polyanhydrides. The dissolvable packet body 504 may also comprise any water-soluble material that is considered generally recognized as safe (“GRAS”) by the U.S. Food and Drug Administration (e.g., on the FDA's GRAS list).

As exemplified in FIG. 7A-7C, the packet body 504 may be configured as an elongate sachet (e.g., a tube closed at top and bottoms ends). Such a sachet configuration may provide one or more advantages. For example, it may be simple to manufacture due to existing and cost-efficient manufacturing processes. Alternatively, or in addition, the elongate sachet configuration may be easily held in a user's hand, ripped at one end, and its contents cleanly poured from the single compartment 508 into a carbonation chamber 140 (e.g., FIG. 30). In another example, the packet body 504 may be configured as a rectangular sachet (e.g., similar in shape to a wrapper for a tea bag).

In another example, the granular carbonate material 512, the granular acid material 516 and the granular desiccant material 520 may be provided in tablet form. In this example, the packet body 504 may be configured as a tablet wrapper that can be removed from the tablet prior to its use.

The packet body 504 can be made from any material or combination of materials that allows the carbon dioxide generating material 164 to be released from the single compartment 508 defined by the packet body 504. In some examples, the material(s) with which to make packet body 504 are selected to limit the amount of moisture that may pass into the single compartment 508. That is, some packet body materials are better at preventing moisture from entering the single compartment 508 than others.

As described above with respect to the example in FIGS. 6A-6D, the packet body 504 may be formed of a water-soluble synthetic polymer, such as polyvinyl alcohol (PVA). In this example, the packet body 504 at least partially dissolves to release the granular carbonate material 512, the granular acid material 516 and the granular desiccant material 520 from the single compartment 508.

In some examples, the packet body 504 may be made of a compostable material. In other examples, the packet body 504 may be at least partially made of a plant-based material (e.g., at least 25% plant-based, at least 50% plant-based, at least 75% plant-based, or 100% plant-based in composition). In yet another example, the packet body 504 may be made of a compostable and plant-based material.

In some examples, the packet body 504 may be made of foil. In other examples, the packet body 504 may be made of a multi-layer foil (meaning a plastic/foil combination). In still other examples, the packet body 504 may be at least partially made of polypropylene (e.g., at least 25% polypropylene, at least 50% polypropylene, at least 75% polypropylene, or 100% polypropylene in composition). Polypropylene may be advantageous due to its recyclability.

In the example shown in FIGS. 7A-7C, the packet body 504 is made of polypropylene. The single compartment 508 is at least partially openable to release the carbon dioxide generating material 164 therefrom. As shown in FIG. 7A, one end of the packet body 504 comprises a tear tab 524 for opening the single compartment 508. The tear tab 524 may be formed by a perforation or a line of weakness 528 in the packet body 504. In other examples, the packet body 504 may not comprise a tear tab to facilitate release of the carbon dioxide generating material 164 from the single compartment 508. In these examples, a user may tear the packet body 504 (e.g., with their hands or with scissors) to at least partially open the single compartment 508. A packet body 504 made of compostable material and/or plant-based material may be easier to tear open by hand than one made of polypropylene.

The granular carbonate material 512 may comprise one or more water soluble carbonates (e.g., potassium bicarbonate KHCO₃, sodium bicarbonate NaHCO₃, ammonium carbonate (NH₄)₂CO₃, lithium carbonate Li₂CO₃, etc.). The granular acid material 516 may comprise one or more carboxylic acids in powdered form (e.g., citric acid C₆H₈O₇, acetic acid CH₃COOH, propionic acid C₃H₆O₂, etc.). In general, smaller carboxylic acids (one to five carbon atoms) tend to be more soluble in water than larger carboxylic acids (six carbon atoms and above) due to the increasing hydrophobic nature of the hydrocarbon chains.

In some examples, the granular carbonate material 512 is granular sodium bicarbonate and the granular acid material 516 is granular citric acid. Sodium bicarbonate and citric acid are advantageous for mixing with water because their reaction does not create heat (i.e., an endothermic reaction). This may be desirable for producing a cooled carbonated beverage. In addition, the reaction of sodium bicarbonate and citric acid generates carbon dioxide gas having little to no taste. This can be advantageous for carbonating beverages since the taste of the carbon dioxide gas should not detract from the taste of the beverage itself. Moreover, granular citric acid and sodium bicarbonate may be relatively inexpensive, non-toxic, easy to transport, and easy to handle. All else being equal, sodium bicarbonate may generate more carbon dioxide gas than the same quantity of other carbonates. In alternative examples, granular carbonate material 512 and granular acid material 516, when mixed in an aqueous solution, may react exothermically to produce carbon dioxide gas.

The granular desiccant material 520 may comprise one or more water soluble desiccants (e.g., calcium chloride CaCl₂), calcium sulfate CaSO₄, magnesium sulfate MgSO₄, magnesium perchlorate Mg(ClO₄)₂, potassium carbonate K₂CO₃, potassium hydroxide KOH, sodium chloride NaCl, sodium sulfate Na₂SO₄, sucrose C₁₂H₂₂O₁₁, etc.). The granular desiccant material 520 is preferably provided in powder form (e.g., has a fine particle size). A granular desiccant material 520 having a fine particle size can be advantageous in examples where the granular desiccant material 520 is mixed with the granular carbonate material 512 and the granular acid material 516 within the single compartment 508. In these examples, the fine particle size of the desiccant material 520 can disperse between the granular carbonate material 512 and the granular acid material 516 to act as a barrier between the granular carbonate material 512 and the granular acid material 516.

Alternatively, or in addition, a granular desiccant material 520 having a fine particle size can increase the availability of the desiccant in the single compartment 508 compared to a granular desiccant material 520 having a larger particle size. All else being equal, the finer the particle size of the granular desiccant material 520, the greater the available surface area of a given quantity. Because it has more available surface area, a granular desiccant material 520 having a fine particle size may absorb more water than a granular desiccant material 520 having a larger particle size.

Alternatively, or in addition, a granular desiccant material 520 having a fine particle size (e.g., a powder) can more readily dissolve in water than one having a larger particle size. In some cases, a granular desiccant material 520 with too large a particle size may not fully dissolve during a carbonation process (e.g., a short carbonation cycle). This can leave behind undissolved desiccant material that can clog valves and/or degrade the performance of the beverage carbonator 104 (FIG. 3).

The granular desiccant material 520 may provide one or more advantages beyond its ability to prevent premature reaction between the granular carbonate material 512 and granular acid material 516 within the single compartment 508. As an example, the granular desiccant material 520 may contribute to carbon dioxide gas production. That is, the granular desiccant material 520 may react with the granular carbonate material 512 and/or the granular acid material 516 when mixed in an aqueous solution. This can be advantageous as the inclusion of the granular desiccant material 520 can reduce the quantity of granular acid material 516 needed to generate a predetermined volume of carbon dioxide gas.

Alternatively, or in addition, the granular desiccant material 520 may react exothermically with the granular carbonate material 512 and/or the granular acid material 516 when mixed in an aqueous solution. This can be advantageous for carbonating beverages as the generated heat may speed up carbon dioxide gas production (i.e., the heat speeds up the reaction between the granular carbonate material 512 and the granular acid material 516). A shorter carbonation cycle may be needed to generate a given quantity of carbon dioxide gas when carbon dioxide gas production is sped up by the inclusion of the granular desiccant material 520.

Alternatively, or in addition, the reaction between the granular carbonate material 512, the granular acid material 516 and the granular desiccant material 520 may generate a byproduct waste that is liquid, clear, safe to handle, safe to dispose and/or relatively odourless. This can be advantageous from a user enjoyment perspective as the byproduct waste is inoffensive and may be easily disposed of down a drain.

In some examples, the granular desiccant material 520 may comprise sodium chloride (NaCl). Compared to other soluble desiccants, sodium chloride may be inexpensive and readily available. Moreover, the reaction between granular carbonate material 512, granular acid material 516 and sodium chloride (NaCl) may generate a byproduct waste that is liquid, clear and relatively odour free. Compared to other soluble desiccants (e.g., MgSO₄ (anhydrous), CaCl₂)), sodium chloride may be a weaker drying agent (e.g., have a lower water retention capacity). This may result in a greater quantity of sodium chloride being needed within the single compartment 508 compared to a more efficient drying agent.

In other examples, the granular desiccant material 520 comprises anhydrous magnesium sulfate (MgSO₄), calcium chloride (CaCl₂)), or a combination thereof. Anhydrous magnesium sulfate and calcium chloride are efficient drying agents, in part because they come as a fine powder with a large surface area. Anhydrous magnesium sulfate and/or calcium chloride may be advantageous for mixing with the granular carbonate material 512 and the granular acid material 516 because they add little to no taste to the generated carbon dioxide gas. This can be advantageous for carbonating beverages since the taste of the carbon dioxide gas should not detract from the taste of the beverage itself. Moreover, anhydrous magnesium sulfate and/or calcium chloride may be relatively inexpensive, non-toxic, easy to transport, and easy to handle.

The quantity of the granular desiccant material 520 sealed within the single compartment may vary depending on shelf-life requirements of the carbonation packet 500. All else being equal, the greater the quantity of granular desiccant material 520 sealed within the single compartment 508 along with the granular carbonate material 512 and the granular acid material 516, the longer the shelf life of the carbonation packet 500. This is because there is more granular desiccant material 520 available to bind with water over time. However, providing too much granular soluble desiccant 520 within the single compartment 508 may cause the byproduct waste to harden (e.g., precipitate out of solution). It is preferable for the byproduct waste to remain liquid for easier disposal and/or maintenance. The quantity of granular desiccant material 520 to be provided within the single compartment 508 is generally a balance between extending shelf-life on one hand and simplifying waste collection and lowering cost on the other hand.

In some examples, between 1 and 5 grams of granular desiccant material 520 may be sealed within the single compartment 508, such as for example, 1.5 to 4 grams, such as approximately 2 to 3 grams. In some examples, a mass ratio of granular carbonate material 512 to granular desiccant material 520 sealed within the single compartment 508 is between 2:1 and 10:1, such as for example, between 4:1 and 8:1, such as approximately between 5:1 and 7:1. In some examples, a mass ratio of granular acid material 516 to granular desiccant material 520 sealed within the single compartment 508 is between 2:1 and 10:1, such as for example, between 2:1 and 7:1, such as approximately between 4:1 and 6:1.

In some examples, between 5 and 25 grams of granular carbonate material 512 may be sealed within the single compartment 508, such as for example, 10 to 20 grams, such as approximately 10 to 15 grams. In some examples, between 5 and 25 grams of granular acid material 516 may be sealed within the single compartment 508, such as for example, 5 to 15 grams, such as approximately 8 to 15 grams. In some examples, a mass ratio of granular carbonate material 512 to granular acid material 516 sealed within the single compartment 508 is between 1:1 and 3:1, such as for example, between 1:1 and 2:1, such as approximately between 1:1 and 1.5:1.

In some examples, the granular carbonate material 512, the granular acid material 516, and the granular desiccant material 520 sealed within the single compartment 508 have a collective mass between 10 and 50 grams, such as for example, 15 to 40 grams, such as approximately 20 to 30 grams.

The granular desiccant material 520 has a water retention capacity. In some examples, the granular desiccant material 520 delays the granular carbonate material 512 from reacting with the granular acid material 516 until the water retention capacity of the granular desiccant material is surpassed. Once the water retention capacity of the granular desiccant material is surpassed, the granular carbonate material 512 is reactive with the granular acid material 516 in water to generate carbon dioxide gas. As used herein and in the claims, the water retention capacity refers to the number of moles of water that one mole of the granular desiccant material 520 can bind. In some examples the water retention capacity of the granular desiccant material is 0.5 to 10, such as for example, 2 to 8, such as approximately 5 to 9.

As an example, anhydrous magnesium sulfate (MgSO₄) readily hydrates according to:

MgSO₄+7H₂O→MgSO₄·(H₂O)₇

Accordingly, the water retention capacity of MgSO₄ (anhydrous) is 7. Therefore, up to 7 moles of water can be absorbed by 1 mole of MgSO₄ (anhydrous). The water retention capacity of anhydrous magnesium sulfate can alternatively be expressed as the mass of water (in grams) that 1 gram of the anhydrous magnesium sulfate can absorb. This can be calculated as follows:

(1) Determine the mass of 7 moles of water (H₂O). The molar mass of water is 18.0158 g/mol.

$$7 moles {H}_{2} O \times \frac{18. 158 g {H}_{2} O}{1 mole {H}_{2} O} = 126.11 g {H}_{2} O$$

(2) Determine the mass of 1 mole of anhydrous magnesium sulfate (MgSO₄). The molar mass of anhydrous magnesium sulfate is 120.366 g/mol.

$$1 mole {MgSO}_{4} ( anhydrous ) \times \frac{120.3 \; 66 g {MgSO}_{4} ( anhydrous )}{1 mole {MgSO}_{4} ( anhydrous )} = 12 \; 0.3 \; 36 g {MgSO}_{4}$$

(3) Calculate the mass of water that 1 gram of the anhydrous magnesium sulfate can bind by dividing the mass of water determined in (1) with the mass of anhydrous magnesium sulfate determined in (2).

$$\frac{1 26.11 grams {H}_{2} O}{120.3 \; 66 grams {MgSO}_{4} ( anhydrous )} = \frac{1.05 g {H}_{2} O}{1 g {MgSO}_{4} ( anhydrous )}$$

Accordingly, up to 1.05 grams of water can be bound by 1 gram of anhydrous magnesium sulfate. For example, if the granular desiccant material 520 sealed within the single compartment 508 comprises 2 grams of anhydrous magnesium sulfate it may absorb up to approximately 2.1 grams of water. Therefore, exposure to more than 2.1 grams of water may surpass the water retention capacity of 2 grams of MgSO₄ (anhydrous). As described above, once the water retention capacity of the granular desiccant material is surpassed, the granular carbonate material 512 is reactive with the granular acid material 516 in water to generate carbon dioxide gas.

As another example, calcium chloride (CaCl₂)) readily hydrates according to:

CaCl₂+6H₂O→CaCl₂·(H₂O)₆

Accordingly, the water retention capacity of CaCl₂) is 6. Therefore, up to 6 moles of water can be absorbed by 1 mole of CaCl₂). The water retention capacity of calcium chloride can alternatively be expressed as the mass of water (in grams) that 1 gram of the calcium chloride can absorb. This can be calculated as follows:

(1) Determine the mass of 6 moles of water (H₂O). The molar mass of water is 18.0158 g/mol.

$$6 moles {H}_{2} O \times \frac{18.0 \; 158 g {H}_{2} O}{1 mole {H}_{2} O} = 108.0 \; 95 g {H}_{2} O$$

(2) Determine the mass of 1 mole of anhydrous magnesium sulfate (MgSO₄). The molar mass of anhydrous magnesium sulfate is 120.366 g/mol.

$$1 mole {CaCl}_{2} \times \frac{1 10.98 g {CaCl}_{2}}{1 mole {CaCl}_{2}} = 1 10.98 g {CaCl}_{2}$$

(3) Calculate the mass of water that 1 gram of the calcium chloride can bind by dividing the mass of water determined in (1) with the mass of calcium chloride determined in (2).

$$\frac{108.095 grams {H}_{2} O}{110.98 grams {CaCl}_{2}} = \frac{0.97 g {H}_{2} O}{1 g {MgSO}_{4} {CaCl}_{2}}$$

Accordingly, up to 0.97 grams of water can be bound by 1 gram of calcium chloride. For example, if the granular desiccant material 520 sealed within the single compartment 508 comprises 3 grams of calcium chloride it may absorb up to approximately 2.9 grams of water. Therefore, exposure to more than 2.9 grams of water may surpass the water retention capacity of 3 grams of CaCl₂). As described above, once the water retention capacity of the granular desiccant material is surpassed, the granular carbonate material 512 is reactive with the granular acid material 516 in water to generate carbon dioxide gas.

As shown in the examples above, anhydrous magnesium sulfate has a higher water retention capacity than calcium chloride. A given mass of anhydrous magnesium sulfate can also absorb a larger quantity of water than that same mass of calcium chloride. Accordingly, anhydrous magnesium sulfate may be preferred over calcium chloride for use as the granular desiccant material 520. Anhydrous magnesium sulfate may also be preferred over calcium chloride because its reaction with granular carbonate material 512 and granular acid material 516 produces a liquid byproduct waste. The reaction of calcium chloride with the granular carbonate material 512 and the granular acid material 516 may generate a solid byproduct waste. The solid byproduct waste may clog the beverage carbonator 104 (FIG. 3) and/or be difficult to clean.

In some examples, the granular carbonate material 512 is granular sodium bicarbonate, the granular acid material 516 is granular citric acid, and the granular desiccant material 520 is anhydrous magnesium sulfate. Sodium bicarbonate, citric acid and anhydrous magnesium sulfate are advantageous for mixing with water because their reaction generates carbon dioxide gas having little to no taste. This can be advantageous for carbonating beverages since the taste of the carbon dioxide gas should not detract from the taste of the beverage itself. Moreover, granular citric acid, sodium bicarbonate and anhydrous magnesium sulfate may be relatively inexpensive, non-toxic, easy to transport, and easy to handle.

Anhydrous magnesium sulfate may provide one or more advantages beyond its ability to prevent premature reaction between sodium bicarbonate and citric acid material within the single compartment 508. As an example, the anhydrous magnesium sulfate may contribute to carbon dioxide gas production. That is, the anhydrous magnesium sulfate may react with the sodium bicarbonate and/or the citric acid when mixed in an aqueous solution. This can be advantageous as the inclusion of the anhydrous magnesium sulfate can lower the quantity of citric acid needed to generate a predetermined volume of carbon dioxide gas.

Alternatively, or in addition, the anhydrous magnesium sulfate may react exothermically with the sodium bicarbonate and the citric acid when mixed in an aqueous solution. This can be advantageous for carbonating beverages as the generated heat speeds up carbon dioxide gas production (i.e., the heat speeds up the reaction between the sodium bicarbonate and the citric acid). A shorter carbonation cycle may be needed to generate a given quantity of carbon dioxide gas when carbon dioxide gas production is sped up using anhydrous magnesium sulfate as granular desiccant material 520.

Alternatively, or in addition, the reaction between sodium bicarbonate, citric acid and anhydrous magnesium sulfate may generate a byproduct waste that is liquid, clear, safe to handle, safe to dispose and/or relatively odourless. This can be advantageous from a user enjoyment perspective as the byproduct waste is inoffensive and can be easily disposed of down a drain. One way that anhydrous magnesium sulfate may make the byproduct waste safer to handle is by bringing its pH closer to 7 (i.e., neutral). For example, the reaction between sodium bicarbonate and citric acid can produce a byproduct waste having an acidic pH of approximately 4-5. However, the reaction sodium bicarbonate, citric acid and anhydrous magnesium sulfate produces a byproduct waste with a pH of approximately 6-7. A pH of 6-7 can be easier on the skin than a pH of 4-5.

In the presence of water, citric acid C₆H₈O₇, sodium bicarbonate NaHCO₃ and anhydrous magnesium sulfate MgSO₄ react to form sodium citrate NaC₆H₅O₇, water H₂O, sodium sulfate Na₂SO₄, magnesium hydroxide Mg(OH₂) and carbon dioxide CO₂. The reaction may be written as:

C₆H₈O₇+5NaHCO₃+MgSO₄(anhydrous)→3NaC₆H₅O₇+3H₂O+Na₂SO₄+Mg(OH)₂+5CO₂

Accordingly, the reaction of citric acid, sodium bicarbonate and anhydrous magnesium sulfate within the carbonation chamber 140 produces sodium citrate, water, sodium sulfate, magnesium hydroxide and carbon dioxide gas. Water, sodium citrate, sodium sulfate and magnesium hydroxide, may be referred to herein as “byproduct waste”. In some examples, the byproduct waste may have a viscosity greater than water. In other examples, the byproduct waste may have viscosity equal to or less than water. The viscosity of the byproduct waste is dependent on the type of granular carbonate material 512, granular acid material 516 and granular desiccant material 520. In examples where the carbonation packet 500 comprises a dissolvable packet body 504 (e.g., FIGS. 6A-6D), the byproduct waste may also comprise the dissolved packet body 504.

As described above, the byproduct waste may be discharged from carbonation chamber 140 into byproduct waste container 160 via byproduct outlet 156 (FIG. 3). It will be appreciated that the composition of the byproduct waste depends on which granular carbonate material 512, granular acid material 516, and granular desiccant material 520 are sealed in the single compartment 508 of carbonation packet 500 (and, in some cases, the composition of the dissolvable packet body 504). That is, different combinations of granular carbonate material 512 (e.g., potassium bicarbonate), granular acid material 516 (e.g., acetic acid), and granular desiccant material 520 (e.g., NaCl, CaCl₂)) generate different byproduct waste compositions.

The commonly accepted industry measurement of carbonation level is volume of CO₂ gas (in litres, measured at the temperature of the beverage) over the volume of carbonated beverage (in litres), typically expressed as a ratio over 1. For example, a carbonation level of 2.5 equates to 2.5 L of CO₂ gas absorbed in 1 L of carbonated beverage. Generally, a carbonated beverage with a carbonation level above 3.0 is perceived as strongly carbonated, while a carbonated beverage with a carbonation level above 3.5 is perceived as very strongly carbonated.

In some examples, the single compartment 508 may have a volume between 10 and 50 mL, such as for example, 15 to 40 mL, such as approximately 20 to 30 mL. It will be appreciated that the volume of single compartment 508 may be based on the quantity of granular carbonate material 512, and the granular acid material 516, and the granular desiccant material 520 sealed therein. That is, the volume of single compartment 508 must be sufficient to accommodate respective quantities of granular carbonate material 512, granular acid material 516, and granular desiccant material 520.

In some examples, the quantity of granular carbonate material 512, granular acid material 516, and granular desiccant material 520 may be selected so that when reacted in water a sufficient volume of carbon dioxide gas is generated to carbonate a beverage to a very high carbonation level (e.g., a carbonation level of at least 4). This can allow carbonation packet 500 to generate a sufficient volume of carbon dioxide gas to carbonate a beverage to any target carbonation level at or below this very high carbonation level. In terms of both manufacturing cost and consumer ease, it may be advantageous to produce one standardized carbonation packet 500 that can be used to produce a carbonated beverage within a wide range of carbonation levels (e.g., from very low to very high carbonation).

In some examples, an aqueous mixture of granular carbonate material 512, granular acid material 516, and granular desiccant material 520 generates between 2 and 6 L of carbon dioxide gas, such as for example 2.5 to 5 L, such as approximately 3.5 to 4.5 L (measured at a pressure of 1 atm and a temperature of 25° C.).

As an example, carbonation packet 500 may have 13 g of granular sodium bicarbonate sealed within single compartment 508. When mixed in water, 13 g of granular sodium bicarbonate can react with granular acid material 516 to generate up to 3792 mL of carbon dioxide gas (measured at 1 atm and 25° C.). This can be calculated as follows:

(1) Determine the mole-to-mole ratio of sodium bicarbonate (NaHCO₃) to carbon dioxide (CO₂) from balanced equation.

C₆H₈O₇+5NaHCO₃+MgSO₄(anhydrous)→3NaC₆H₅O₇+3H₂O+Na₂SO₄+Mg(OH)₂+5CO₂

The mole-to-mole ratio of NaHCO₃ to CO₂ from balanced equation is 5:5 (or 1:1).

(2) Estimate the molar volume of CO₂ using the ideal gas law at a pressure of 1 atm and a temperature of 298 K (approximately 25° C.)

$$\frac{V}{n} = \frac{R T}{P} = \frac{( 82.06 mL \cdot atm \cdot {mol}^{- 1} \cdot {K}^{- 1} ) \times ( 298 K )}{1 atm} = 2.445388 \times {10}^{4} mL / mol$$

The molar volume of carbon dioxide is 2.45×10⁴ mL/mol at a pressure of 1 atm and a temperature of 298 K.

(3) Determine the molar mass of sodium bicarbonate (NaHCO₃). The atomic weights of sodium (NA), hydrogen (H), carbon (C) and oxygen (O) are 22.99, 1.01, 12.01, and 16, respectively.

$$22.99 + 1.01 + 12.01 + 3 \cdot ( 16. ) = 84. g / mol {NaHCO}_{3}$$

The molar mass of sodium bicarbonate is approximately 84.0 g/mol.

(4) Convert grams (g) of sodium bicarbonate (NaHCO₃) into millilitres (mL) of carbon dioxide (CO₂) gas using the mole-to-mole ratio of NaHCO₃ to CO₂ determined in (1), the molar volume of CO₂ estimated in (2) and the molar mass of NaHCO₃ determined in (3).

$$13 g {NaHCO}_{3} \times ( \frac{1 mol {NaHCO}_{3}}{84. g {NaHCO}_{3}} ) \times ( \frac{2.45 \times 1 {0}^{4} mL {CO}_{2}}{1 mol {CO}_{2}} ) = 3792 ml {CO}_{2}$$

Accordingly, a carbonation packet 500 with 13 g of granular sodium bicarbonate sealed within single compartment 508 can generate approximately 3.8 L of carbon dioxide gas if fully reacted. Sealing a sufficient quantity of granular acid material 516 within single compartment 508 can help ensure that all of the provided granular sodium bicarbonate is reacted. This can maximize carbon dioxide gas production for a given quantity of granular sodium bicarbonate. For example, to fully react 13 g of granular sodium bicarbonate, approximately 5.95 g of granular citric acid can be sealed within single compartment 508. This can be calculated as follows:

(1) Determine the mole-to-mole ratio of citric acid (C₆H₈O₇) to sodium bicarbonate (NaHCO₃) from balanced equation.

C₆H₈O₇+5NaHCO₃+MgSO₄(anhydrous)→3NaC₆H₅O₇+3H₂O+Na₂SO₄+Mg(OH)₂+5CO₂

The mole-to-mole ratio of C₆H₈O₇ to NaHCO₃ from balanced equation is 1:5

(2) Determine the molar mass of citric acid (C₆H₈O₇) and sodium bicarbonate (NaHCO₃). The atomic weights of carbon (C), hydrogen (H), and oxygen (O) are 12.01, 1.01, and 16, respectively.

$$6 \cdot ( 12.01 ) + 8 \cdot ( 1.01 ) + 7 \cdot ( 16. ) = 192.14 g / mol {C}_{6} {H}_{8} {O}_{7}$$

The molar mass of citric acid is approximately 192.14 g/mol. The molar mass of sodium bicarbonate is approximately 84.0 g/mol (calculated above).

(3) Convert grams (g) of sodium bicarbonate (NaHCO₃) into grams (g) of citric acid (C₆H₈O₇) using the mole-to-mole ratio of C₆H₈O₇ to NaHCO₃ determined in (1), and the molar mass of C₆H₈O₇ and NaHCO₃ determined in (2).

$$13 g {NaHCO}_{3} \times ( \frac{1 mol {NaHCO}_{3}}{84. g {NaHCO}_{3}} ) \times ( \frac{1 mol {C}_{6} {H}_{8} {O}_{7}}{5 mol {NaHCO}_{3}} ) \times ( \frac{1 92.14 g {C}_{6} {H}_{8} {O}_{7}}{1 mol {C}_{6} {H}_{8} {O}_{7}} ) = 5.95 g {C}_{6} {H}_{8} {O}_{7}$$

Thus, 5.95 g of citric acid is needed to fully react 13 g of sodium bicarbonate. The required mass of citric acid to react 13 g of sodium bicarbonate would be greater than 5.95 g if anhydrous magnesium sulfate was omitted from the reaction. As shown above, the mole ratio of citric acid to sodium bicarbonate in the balanced reaction equation is 1:5 when anhydrous magnesium sulfate is included in the reaction. In contrast, without anhydrous magnesium sulfate included in the reaction, the mole ratio of citric acid to sodium bicarbonate in the balanced reaction equation is 1:3. In other words, less citric acid is needed to fully react a given quantity of sodium bicarbonate with anhydrous magnesium sulfate participating in the reaction. Therefore, the inclusion of the anhydrous magnesium sulfate can lower the quantity of citric acid needed to fully react with a given quantity of sodium bicarbonate.

In some examples, the quantity of granular citric acid sealed within single compartment 508 is increased above the quantity calculated to fully react a given quantity of sodium bicarbonate in order to provide a buffer (i.e., a margin of error). Using the example above, the calculated 5.95 g of citric acid can be increased to 11 g of citric acid, or even higher, to ensure that all 13 g of sodium bicarbonate reacts to generate carbon dioxide gas.

Accordingly, a carbonation packet 500 with 13 g of granular sodium bicarbonate and 11 g of granular citric acid sealed within the single compartment 508 can generate approximately 3.8 L of carbon dioxide gas (measured at 1 atm and 25° C.). For systems where beverage container 108 has a maximum inner volume 116 of 750 mL, this is enough carbon dioxide gas to achieve a very strong carbonation level within the beverage. If all of the CO₂ gas generated from carbonation packet 500 were to dissolve in a full beverage container 108 (750 mL) with a beverage temperature of 25° C., the final carbonated beverage would have a very strong carbonation level of 5.1 (3.8 L CO₂ gas/0.75 L carbonated beverage). A carbonation level of 4.0 (measured at the beverage temperature) is generally perceived as an upper carbonation level (i.e., a carbonation level above which its drinker is unlikely to find appealing). Accordingly, this particular carbonation packet 500 can generate sufficient carbon dioxide gas to carbonate a 750 mL beverage to an upper carbonation level of 4.0 with carbon dioxide gas to spare. In some cases, a portion of the carbon dioxide gas generated within carbonation chamber 140 may be lost due to system headspace and inefficiencies. In this context, the spare or excess carbon dioxide gas may be characterized as a buffer, which can make up for any carbon dioxide gas that is lost. For this reason, it can be advantageous to provide slightly more carbon dioxide generating materials within carbonation packet 500 than needed.

The example above is intended for illustrative purposes. It illustrates how one can determine a volume of carbon dioxide gas that can be generated when specific quantities of sodium bicarbonate and citric acid are mixed in water. For example, the quantities of granular sodium bicarbonate and granular citric acid sealed within the single compartment 508 of carbonation packet 500 can be selected so that when mixed in water they react to generate a targeted volume of carbon dioxide gas (e.g., 2.5 L, 3 L, 3.5 L, 4 L, etc.—measured at 1 atm and 25° C.). Those skilled in the art will appreciate that similar calculations can be made for different types of granular carbonate material 512 (e.g., potassium bicarbonate), granular acid material 516 (e.g., acetic acid), granular desiccant material 520 (e.g., NaCl, CaCl₂)), and/or at different pressures and temperatures.

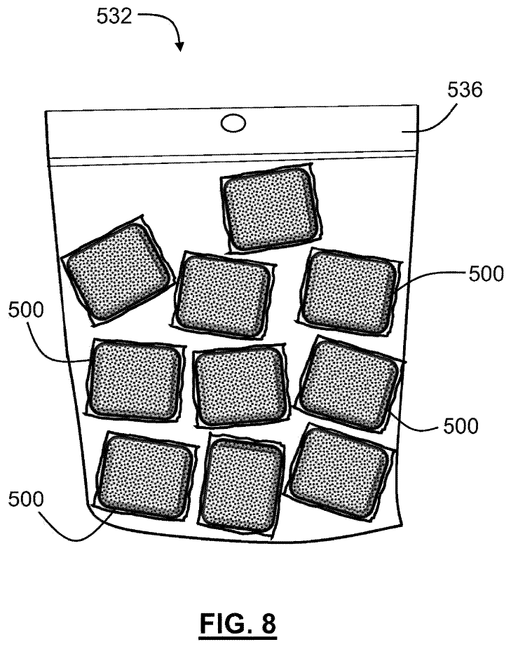

FIG. 8 illustrates a retail package 532 that comprises a plurality of carbonation packets 500. As shown, the retail package 532 comprises ten of carbonation packets 500 of FIGS. 6A-6D. It will be appreciated that a retail package 532 can also comprise any number of the carbonation packets 500 of FIG. 7A-7C. Retail package 532 is shown configured as a pouch with a sealable top portion 536. Various configurations are possible. For example, retail package 532 may be alternatively configured as a container with an openable lid.

Retail packages 532 may come in one or more sizes (i.e., comprise different numbers of carbonation packets 500). As an example, a retail package 532 may come with 5 to 50 carbonation packets 500. Accordingly, a customer who purchases such a retail package 532 can carbonate that many beverages of their choosing (e.g., wine, water, apple juice, etc.). As another example, a larger retail package 532 may comprise up to 250 carbonation packets (or more in some cases). In some examples, each carbonation packet 500 in a retail package 532 holds equivalent quantities of granular carbonate material 512 as each other carbonation packet 500, holds equivalent quantities of granular acid material 516 as each other carbonation packet 500, and holds equivalent quantities of granular desiccant material 520 as each other carbonation packet 500. Accordingly, each carbonation packet 500 in retail package 532 may have the same carbon dioxide generating capacity as any other carbonation packet 500 in retail package 532.

In some examples, a retail package 532 may comprise one or more carbonation packets 500 having a different quantity of granular carbonate material 512 as one or more other carbonation packets 500, and/or having a different quantity of granular acid material 516 as one or more other carbonation packets 500 and/or having a different quantity of granular desiccant material 520 as one or more other carbonation packets 500. This can allow a user to select a carbonation packet 500 based on the packet's specific carbon dioxide generating capacity suitability to produce the user's targeted carbonation level. Such carbonation packets 500 may be marked with their associated carbon generating capacity or have an indicia corresponding to their carbon generating capacity.

In other example, a retail package 532 may comprise a quantity of the carbonation packets 500 of FIGS. 6A-6D and a quantity of the carbonation packets 500 of FIGS. 7A-7C. This can allow a user to select a carbonation packet 500 based on their preferred way of depositing carbon dioxide generating material into a carbonation chamber 140. Alternatively, or in addition, it may allow a user to select a carbonation packet 500 that is compatible with their beverage carbonator 104.

FIG. 9 shows a system state (“container connected state”) in which beverage container 108 is connected to beverage carbonator 104, prior to initiating a carbonation operation. Inner volume 116 of beverage container 108 is shown holding a beverage 112 to be carbonated, while water reservoir 144 is shown holding water 146 that can be supplied to carbonation chamber 140. Water reservoir 144 and water 146 may alternatively be referred to herein as “liquid reservoir 144” and “liquid 146”, respectively. As shown, beverage container inlet 120 and carbonator outlet 128 are fluidly coupled, and container outlet 124 and carbonator inlet 132 are fluidly coupled. Carbonation packet 500 of FIGS. 6A-6D is shown received by carbonation chamber 140. Flow valve 152 is shown fluidly connecting water reservoir 144 to pump 148, and fluidly disconnecting gas flow along fluid flow path 136 from carbonator inlet 132 to carbonator outlet 128. Byproduct outlet 156 is closed and pump 148 is deactivated (i.e., not moving fluid).

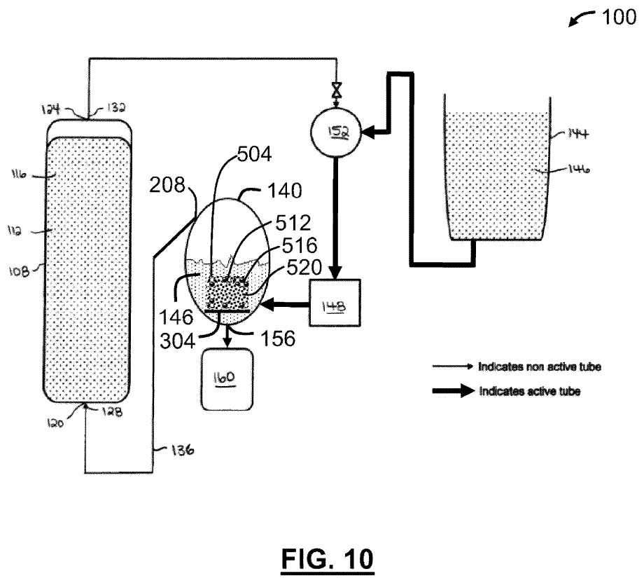

FIG. 10 shows a system state (“reservoir draw state”) shortly after activating beverage carbonator 104. As compared with the state of FIG. 9, pump 148 is activated and water 146 is moved from water reservoir 144 into carbonation chamber 140 to form an aqueous mixture of granular carbonate material 512, granular acid material 516 and granular desiccant material 520 released from partially dissolved packet body 504. The water 146 within the carbonation chamber 140 quickly surpasses the water retention capacity of the granular desiccant material 520. In effect, the granular desiccant material 520 is overwhelmed by the volume of water 144 moved into the carbonation chamber 140. A reaction takes place in the aqueous mixture that generates carbon dioxide gas. The generated carbon dioxide gas may flow from carbonation chamber 140 through beverage container 108 and back into fluid flow path 136 at carbonator inlet 132. Flow valve 152 is shown closing fluid flow path 136 upstream of carbonation chamber 140, which inhibits the carbon dioxide gas that has re-entered carbonator inlet 132 from recirculating back into beverage container 108. In alternative examples, the generated carbon dioxide gas remains in beverage carbonator 104 and does not enter beverage container 108 at all during the reservoir draw state.

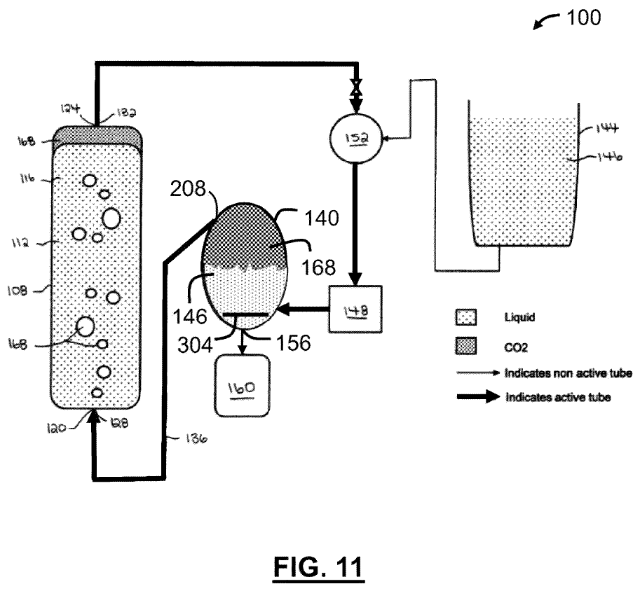

FIG. 11 shows a system state (“gas recirculation state”) shortly after carbon dioxide gas 168 has been generated by the reaction in the aqueous mixture of water 146, granular carbonate material 512, granular acid material 516 and granular desiccant material 520 (FIG. 10) in carbonation chamber 140. Beverage carbonator 104 may be configured to begin recirculating gas in response to achieving a predetermined minimum system gas pressure. For example, pump 148 may be reconfigured from drawing water to recirculating carbon dioxide gas exiting container outlet 124 after a predetermined minimum system gas pressure is achieved. This can allow the system gas pressure upstream and downstream of pump 148 to normalize. This can reduce the pressure drop across pump 148 and thereby reduce the strain on pump 148. Moreover, elevated system gas pressure contributes to keeping the reaction in carbonation chamber 140 acquiescent. By delaying gas recirculation, the system gas pressure can rise quickly, and therefore quickly calm the reaction in carbonation chamber 140, which mitigates the aqueous mixture becoming entrained in the flow of carbon dioxide gas and mixing into beverage 112.

As compared with the state of FIG. 10, flow valve 152 is fluidly disconnecting pump 148 from water reservoir 144, and fluidly connecting pump 148 to carbonator inlet 132. As shown, pump 148 is activated and moving carbon dioxide gas 168 generated in carbonation chamber 140 into beverage container 108 via carbonator outlet 128 and container inlet 120. The carbon dioxide gas 168 exits container outlet 124 into carbonator inlet 132 after contacting beverage 112. Pump 148 recirculates the carbon dioxide gas 168 entering carbonator inlet 132 back into beverage container 108 through carbonator outlet 128 and container inlet 120. The illustrated state may continue for a duration (e.g., 1 to 5 minutes) sufficient to absorb a target concentration of carbon dioxide into beverage 112.

Beverage carbonation system 100 may permit the user to control the carbonation level in the final beverage 112. In general, a shorter duration (e.g., 1 to 2 minutes) of recirculation may produce a less carbonated beverage 112, and a longer duration (e.g., 3 to 5 minutes) of recirculation may produce a more carbonated beverage 112. Alternatively, or in addition, the carbonation level in the final beverage 112 may be varied by the quantity and composition of granular carbonate material 512, granular acid material 516 and/or granular desiccant material 520 originally deposited into the carbonation chamber 140. For example, by mass, sodium bicarbonate can generate a greater volume of carbon dioxide gas than potassium bicarbonate.

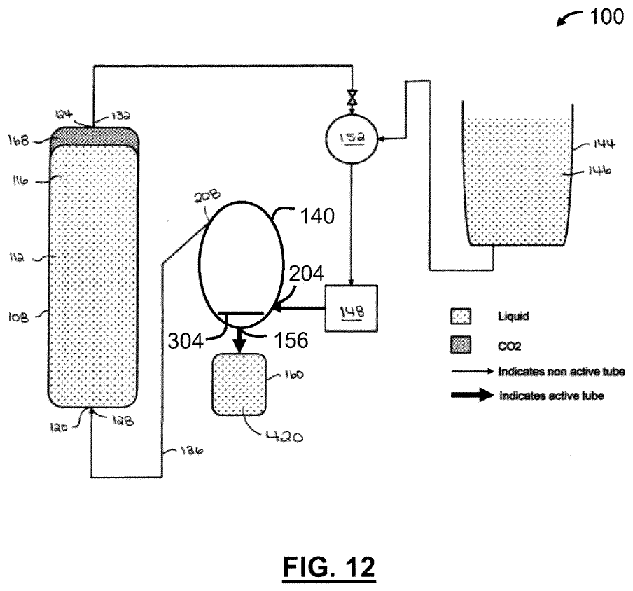

FIG. 12 shows a system state (“container sealed state”) shortly after beverage container 108 has been sealed for removal from beverage carbonator 104. As compared with the state of FIG. 11, beverage container inlet and outlet 120, 124 are disconnected from beverage carbonator 104 and hermetically seal container inner volume 116 to prevent a loss of carbonation from carbonated beverage 112. Further, above-atmospheric pressure is trapped within carbonation chamber 140 (e.g., by closing carbonator outlet 128 and deactivating pump 148), and then byproduct outlet 156 is opened to vent the trapped above-atmospheric gas pressure through byproduct outlet 156 thereby evacuating byproduct waste 420 from carbonation chamber 140 through byproduct outlet 156 into byproduct waste container 160. The user may empty byproduct waste container 160 after carbonating one or many beverage containers 108 of beverage 112. The ability of beverage carbonation system 100 to use the system pressure remaining (i.e., trapped) after carbonation is complete to clear byproduct waste 420 from carbonation chamber 140, can reduce or eliminate any need for users to access and clean carbonation chamber 140. In the result, beverage carbonation system 100 may require less maintenance and therefore provide more convenience to users.

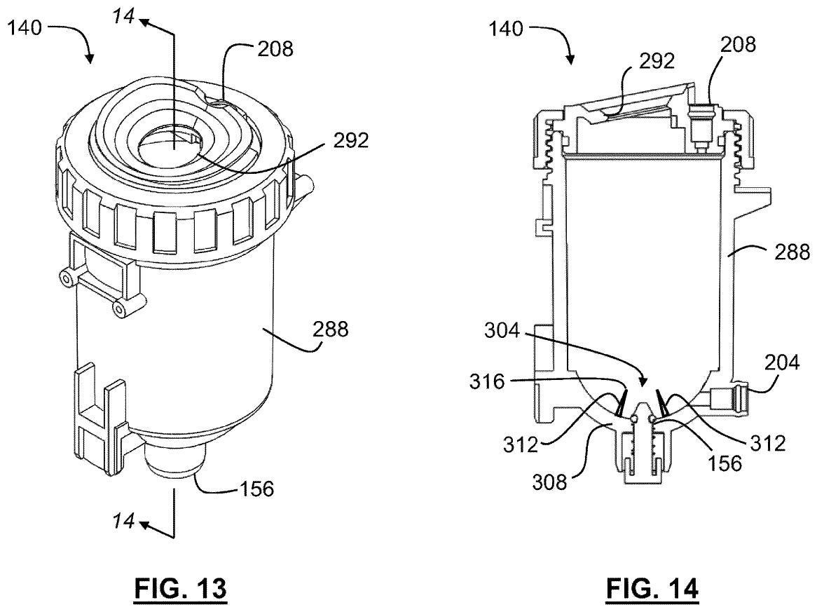

FIGS. 13-14 show an example carbonation chamber, referred to generally as 140. As shown, carbonation chamber 140 may comprise a chamber housing 288 having a fluid inlet 204, a carbon dioxide outlet 208, a carbonation source inlet 292, and a byproduct outlet 156. As shown in FIG. 9, in use, fluid inlet 204 is fluidly coupled to pump 148, carbon dioxide outlet 208 is fluidly coupled to carbonator outlet 128, and byproduct outlet 156 is fluidly coupled to byproduct waste container 160. Returning to FIGS. 13-14, carbonation source inlet 292 may be open or closed according to the corresponding position of an exterior door 296 (FIG. 1).

Referring to FIG. 14, carbonation chamber 140 comprises a carbonation source carrier 304 positioned to receive a carbonation packet 500 deposited into chamber housing 288 through carbonation source inlet 292. In the example shown, carbonation source carrier 304 is partially defined by a lower end 308 of chamber housing 288. In alternative embodiments, carbonation source carrier 304 may comprise a platform, plate, table, or tray located within chamber housing 288. For example, the carbonation chamber 140 shown in FIGS. 9-12 has a carbonation source carrier in the form of a table 304. Referring again to FIG. 14, carbonation source carrier 304 and fluid inlet 204 can be arranged to expose a carbonation packet 500 (FIGS. 6A-6D) received on the carbonation source carrier 304 to water introduced into chamber housing 288 through fluid inlet 204. Carbon dioxide outlet 208 can provide an exit for carbon dioxide gas generated within chamber housing 288.

Fluid inlet 204 may admit carbon dioxide gas into carbonation chamber 140 (e.g., during a gas recirculation system state, FIG. 11). Carbon dioxide gas may enter chamber housing 288 at fluid inlet 204 and exit through gas outlet 208. In some examples, the carbon dioxide gas flow from fluid inlet 204 to gas outlet 208 may help to agitate the aqueous mixture of granular carbonate material 512, granular acid material 516, and granular desiccant material 520 to promote a complete reaction (i.e., leaving no unreacted carbon dioxide generating material). For example, carbon dioxide gas entering at fluid inlet 204 may bubble up through the aqueous mixture before exiting gas outlet 208. This may agitate any remaining granular carbonate material 512 and/or granular acid material 516 that has not completely reacted within the aqueous mixture to generate carbon dioxide gas.

In some examples, carbonation chamber 140 comprises a means for piercing (e.g., puncturing or slicing) packet body 504 of a deposited carbonation packet 500 (FIGS. 6A-6B). Piercing dissolvable packet body 504 may quicken the release of granular carbonate material 512, granular acid material 516 and/or granular desiccant material 520 from the single compartment 508 when water is introduced into chamber housing 288. In turn, this may allow for carbon dioxide gas to be generated quicker than when dissolvable packet body 504 is not pierced. In the example shown, carbonation chamber 140 comprises a pair of piercers 312 that project upwardly from lower end 308 of chamber housing 288. When a carbonation packet 500 is dropped into chamber housing 288 through carbonation source inlet 292, gravity causes it to fall onto sharpened tips 316 of piercers 312, which may puncture, impale, or slice packet body 504. In an alternative example, more (e.g., 3-6) or fewer (e.g., 1) piercers 312 may be positioned within chamber housing 288. In another alternative example, a means for piercing packet body 504 may not be provided.

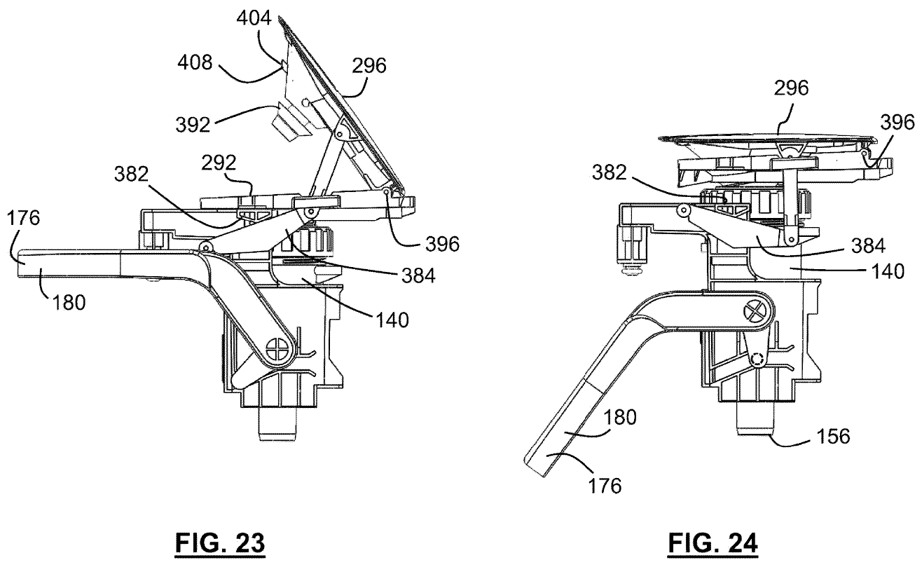

In some examples, piercers 312 may be actuated according to movement of exterior door 296 (FIG. 1). For example, piercers 312 may be mechanically actuated from a retracted state to an extended state when exterior door 296 is closed and/or when the container engagement actuator 176 is moved from the container disengaged position (e.g., lever 180 is fully raised as shown in FIG. 23) to the container engaged position (e.g., lever 180 is fully lowered as shown in FIG. 24). In some examples, one or more actuable piercers 312 are located in a lid of chamber housing 288. In these examples, when the lid closes the carbonation source inlet 292, the piercers 312 move from a retracted to an extended state (i.e., project downwardly) to pierce a deposited carbonation packet 500. Alternatively, actuation of piercers 312 may be controlled electronically (e.g., moved from retracted to extended state automatically when beverage carbonator 104 is activated). Alternatively, or in addition, piercers 312 may comprise one or many blades that when actuated rotate (e.g., swing) to slice packet body 504.

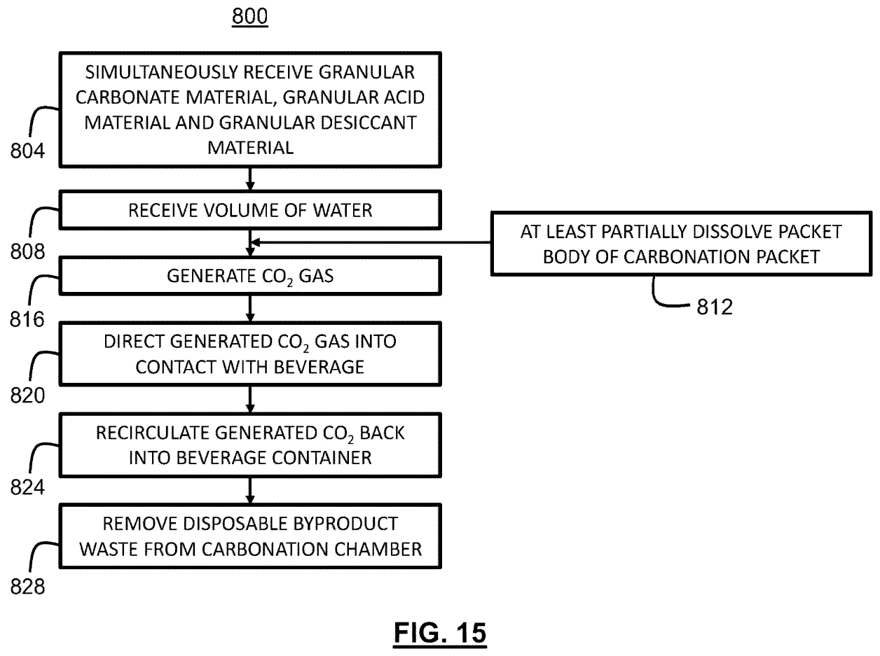

FIG. 15 depicts a flowchart of an example method 800 of generating carbon dioxide gas for a beverage. For clarity of illustration, method 800 is described below with reference to beverage carbonation system 100. However, method 800 is not limited to the use of beverage carbonation system 100 and can be practiced using any suitable carbonation device or system.

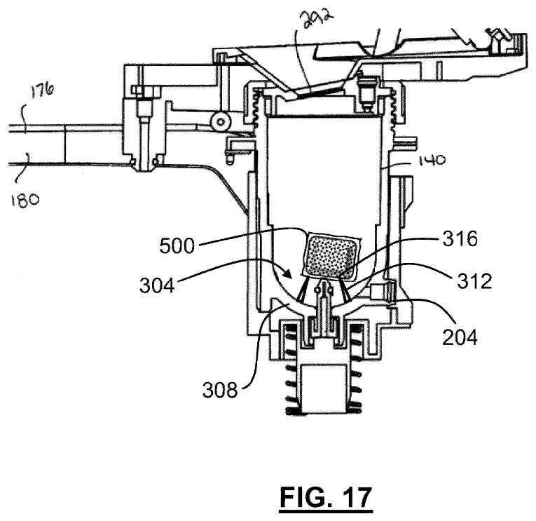

Step 804 involves simultaneously receiving granular carbonate material 512, granular acid material 516 and granular desiccant material 520 by carbonation chamber 140. Step 802 may involve receiving a carbonation packet 500 by carbonation chamber 140 (e.g., FIG. 9). As described above, the carbonation packet 500 may comprise a dissolvable packet body 504 that is flexible and rapidly water-dissolvable. Packet body 504 defines a single compartment 508 that seals the granular carbonate material 512, the granular acid material 516, and the granular desiccant material 520. In some examples, receiving the carbonation packet 500 by the carbonation chamber 140 involves receiving the carbonation packet 500 through a carbonation source inlet 292 of the carbonation chamber 140 (e.g., FIGS. 16-17). The granular desiccant material 520 may keep the granular carbonate material 512 and the granular acid material 516 from reacting while sealed within the single compartment 508 defined by packet body 504.

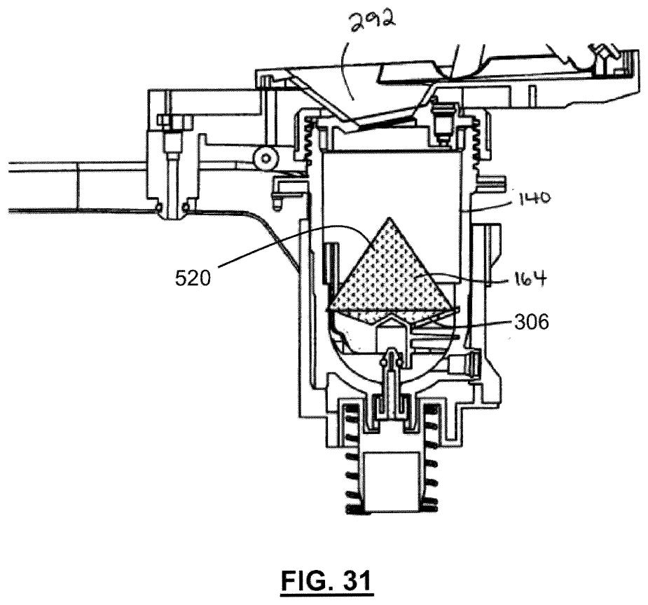

Alternatively, step 804 may involve the carbonation chamber 140 receiving granular carbonate material 512, granular acid material 516 and granular desiccant material 520 that is poured out of carbonation package 500. For example, the single compartment 508 defined by the packet body 504 can be opened so that the granular carbonate material 512, granular acid material 516 and granular desiccant material 520 can be poured into the carbonation chamber 140. In some examples, step 804 involves the carbonation chamber 140 receiving the granular carbonate material 512, granular acid material 516 and granular desiccant material 520 through a carbonation source inlet 292 of the carbonation chamber 140 (e.g., FIGS. 30-31).

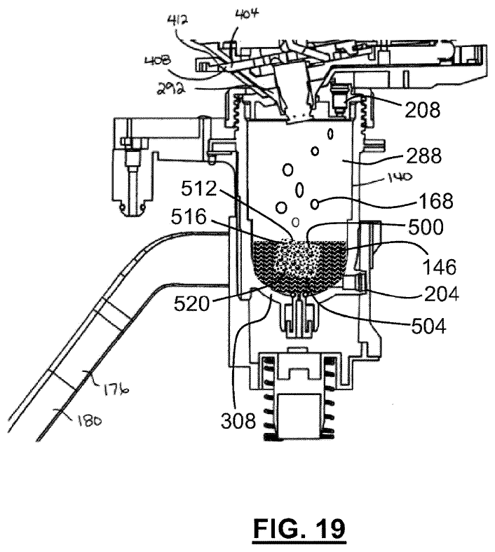

Step 808 involves receiving a volume of water into carbonation chamber 140 (e.g., see FIG. 19). This may involve pumping the volume of water from water reservoir 144 to carbonation chamber 140. For example, pump 148 may be activated to move the volume of water from water reservoir 144 into carbonation chamber 140 at fluid inlet 204. In an alternative example, the volume of water may be moved from water reservoir 144 into carbonation chamber 140 by gravity (e.g., water reservoir 144 is positioned at a higher elevation than fluid inlet 204). In another alternative example, the volume of water may be received from a building's water supply (e.g., a water line may connect fluid inlet 204 to the building's water supply).

The volume of water received into carbonation chamber 140 at step 808 is preferably greater than or equal to a volume of water required to completely react the carbon dioxide generating materials (e.g., sodium bicarbonate and citric acid) received by carbonation chamber 140 at step 802. In some examples, the volume of water received into the carbonation chamber 140 at step 808 is at least 50 mL, such as for example between 80 and 110 mL. The volume of water required to completely react the carbon dioxide generating materials in carbonation chamber 140 may depend on the quantity of granular carbonate material 512, granular acid material 516 and granular desiccant material 520 deposited into carbonation chamber 140, and/or the formulation of the granular carbonate material 512, granular acid material 516 and granular desiccant material 520. In some examples, pump 148 may be configured to cease delivering water from water reservoir 144 to carbonation chamber 140 in response to achieving a predetermined minimum system gas pressure. Waiting until the system gas pressure reaches at least a predetermined minimum pressure before stopping the delivery of water into carbonation chamber 140 may ensure that there is sufficient water for a complete reaction of granular carbonate material 512 and granular acid material 516 received in carbonation chamber 140.

Step 812 involves at least partially dissolving packet body 504 with the volume of water received into carbonation chamber 140 at step 804 (e.g., see FIG. 19). As described above, carbonation packet 500 may comprise a dissolvable packet body 504 that is flexible and rapidly water-dissolvable. As packet body 504 dissolves in the received volume of water, granular carbonate material 512, granular acid material 516, and granular desiccant material 520 is released from previously sealed single compartment 508. In some examples, the received volume of water dissolves between 75% and 100% of the packet body 504, such as for example 90% to 100%, such as approximately 95 to 100% over the course of the carbonation cycle. Step 812 can be omitted when step 804 involves the carbonation chamber 140 receiving granular carbonate material 512, granular acid material 516 and granular desiccant material 520 that is poured from carbonation package 500.

The volume of water received into carbonation chamber 140 at step 808 exceeds a water retention capacity of the granular desiccant material 520. As described above, the granular desiccant material 520 has a water retention capacity. In some examples, the granular desiccant material 520 delays the granular carbonate material 512 from reacting with the granular acid material 516 until the water retention capacity of the granular desiccant material is surpassed. The volume of water received into the carbonation chamber 140 at step 808 quickly surpasses the water retention capacity of the granular desiccant material 520. In effect, the granular desiccant material 520 is overwhelmed by the volume of water received into the carbonation chamber 140.

Step 816 involves generating carbon dioxide gas from a reaction between at least the granular carbonate material 512 and the granular acid material 516. As described above, when in an aqueous mixture, granular carbonate material 512 and granular acid material 516 react to generate carbon dioxide gas. Once the water retention capacity of the granular desiccant material is surpassed by the volume of water received in step 808, the granular carbonate material 512 begins reacting with the granular acid material 516 in an aqueous mixture to generate carbon dioxide gas. In some examples, step 816 involves generating the carbon dioxide gas from the reaction between the granular carbonate material, the granular acid material, and the granular desiccant material (i.e., the granular desiccant material 520 contributes to carbon dioxide gas production). In some examples, an aqueous mixture of granular carbonate material 512, granular acid material 516 and granular desiccant material 520 generates between 2 and 6 L of carbon dioxide gas, such as for example 2.5 to 5 L, such as approximately 3.5 to 4.5 L (measured at a pressure of 1 atm and a temperature of 25° C.).

Step 816 may involve mixing the granular carbonate material 512, the granular acid material 516 and the granular desiccant material 520 that have been received in the carbonation chamber 140. The mixing of the received granular carbonate material 512, granular acid material 516 and granular desiccant material 520 may be performed by the volume of water received into carbonation chamber 140 at step 808. Alternatively, or in addition, carbonation chamber 140 may include one or more mixing elements or agitators that act to mix the received granular carbonate material 512, granular acid material 516 and granular desiccant material 520. The mixing at step 816 may help the granular carbonate material 512 and granular acid material 516 dissolve. Alternatively, or in addition, mixing the granular carbonate material 512, granular acid material 516 and granular desiccant material 520 may increase the speed of the carbon dioxide generating reaction and/or ensure a complete reaction of granular carbonate material 512 and granular acid material 516.

Optionally, method 800 may comprise step 820 which involves directing the generated carbon dioxide gas along a fluid flow path into contact with a beverage 112 in a beverage container 108. As shown in FIG. 9, fluid flow path 136 fluidly connects carbon dioxide outlet 208 of carbonation chamber 140 with container inlet 120. Accordingly, carbon dioxide gas generated in carbonation chamber 140 can be directed (i.e., flow) into beverage container 108 along fluid flow path 136. The carbon dioxide gas may bubble up through the beverage 112 from container inlet 120 to container outlet 124. A portion of the generated carbon dioxide gas that bubbles up through beverage 112 dissolves into and carbonates the liquid beverage 112, while the remaining carbon dioxide gas that does not dissolve can exit through container outlet 124.

Referring again to FIG. 15, method 800 optimally comprises step 824 which involves recirculating the generated carbon dioxide gas that exits beverage container 108 along a fluid flow path and back into beverage container 108. As an example, the carbon dioxide gas exiting container outlet 124 can be recirculated back into container inlet 120 along fluid flow path 136 (e.g., see FIG. 11). As described above, when beverage container 108 is engaged with beverage carbonator 104, container inlet 120 and carbonator outlet 128 are fluidly coupled, and container outlet 124 and carbonator inlet 132 are fluidly coupled. Pump 148 may be activated at step 824 to recirculate carbon dioxide gas along fluid flow path 136 from carbonator inlet 132 to carbonator outlet 128.

Optionally, method 800 comprises step 828 which involves removing byproduct waste from carbonation chamber 140 through a byproduct outlet 156 of carbonation chamber 140. The byproduct waste may include the dissolved or partially dissolved packet body 504. As an example, byproduct outlet 156 can be opened to discharge byproduct waste from carbonation chamber 140 through byproduct outlet 156 into byproduct waste container 160. The user may empty byproduct waste container 160 after carbonating one or many beverage containers 108 of beverage 112. In some embodiments, above-atmospheric pressure can be trapped within carbonation chamber 140 (e.g., by closing carbonator outlet 128 and deactivating pump 148), and then byproduct outlet 156 is opened to vent the trapped above-atmospheric gas pressure through byproduct outlet 156 thereby evacuating byproduct waste from carbonation chamber 140 through byproduct outlet 156 into byproduct waste container 160. Alternatively, or in addition, byproduct outlet 156 may include a release valve that acts to open and close byproduct outlet 156 to evacuate byproduct waste from carbonation chamber 140 into byproduct waste container 160.

Reference is now made to FIGS. 16-22, which illustrate steps in the operation of the carbonation chamber 140 of FIGS. 13-14. FIG. 16 shows carbonation chamber 140 when in the container disengaged position, with exterior door 296 open to allow carbonation packet 500 of FIGS. 6A-6B to be deposited through carbonation source inlet 292. Container engagement actuator 176 is in the disengaged position (e.g., lever 180 is fully raised as shown in FIG. 23). Pump 148 (FIG. 9) is deactivated. In the illustrated state (“container disengaged state”), water reservoir 144 (FIG. 3) may be filled if depleted of water. For example, water reservoir 144 may be filled in-situ (e.g., if not removable from beverage carbonator 104) or may be removed from beverage carbonator 104 to fill and then reconnected to beverage carbonator 104. As shown in FIG. 3, water reservoir 144 has a handle 380 that a user can grasp to remove and replace water reservoir 144 on beverage carbonator 104.

FIG. 17 shows carbonation chamber 140 after carbonation packet 500 has been deposited into carbonation chamber 140 through the opened carbonation source inlet 292. As compared with FIG. 16, carbonation packet 500 has fallen by gravity from carbonation source inlet 292 onto piercers 312. Carbonation packet 500 is shown punctured by piercers 312 at carbonation source carrier 304.

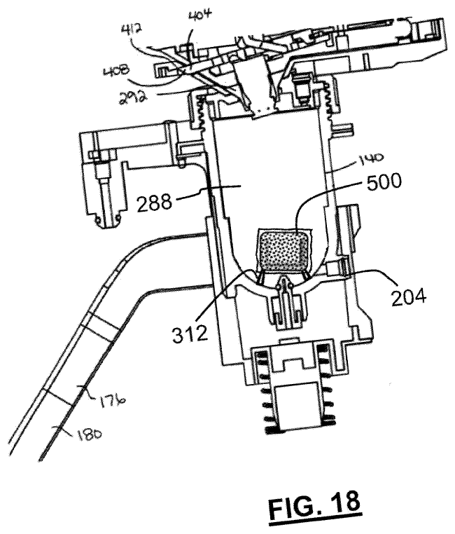

FIG. 18 shows carbonation chamber 140 after exterior door 296 is closed to seal carbonation source inlet 292. Container engagement actuator 176 is in the container engaged position (e.g., lever 180 is fully lowered as shown in FIG. 24). In the example shown, moving container engagement actuator 176 to the container engaged position causes exterior door 296 to close. This may prevent a user from accidentally leaving exterior door 296 open when a carbonation operation is activated. In the example shown, container engagement actuator 176 is mechanically connected to exterior door 296. As shown by comparison of FIGS. 23 and 24, container engagement actuator 176 may drive a door closure guide 382 to bear upon door linkage 384, whereby door linkage 384 articulates to move exterior door 296 to the closed position. In other examples, an electronic controller 388 (FIG. 5) may activate an electro-mechanical device (e.g., motor or solenoid) to close exterior door 296 in coordination with the movement of container engagement actuator 176 to the container engaged position.

In some examples, exterior door 296 can optionally be manually closed by a user prior to moving container engagement actuator 176 to the container engaged position. That is, when container engagement actuator 176 is in the container disengaged position, exterior door 296 may not be prevented from closing. This mitigates a user damaging exterior door 296 by attempting to manually close exterior door 296 while engagement actuator 176 is in the container disengaged position. In this case, moving container engagement actuator 176 to the container engaged position causes exterior door 296 to close only if exterior door 296 was not already manually closed by the user.

Exterior door 296 may seal carbonation source inlet 292 in any manner that inhibits carbon dioxide gas generated within carbonation chamber 140 from escaping through carbonation source inlet 292. In the example shown, exterior door 296 comprises a seal 392 (also referred to as a sealing member, or gasket) that allows exterior door 296 to provide a gas-tight seal of carbonation source inlet 292 when in the closed position. Exterior door 296 may be movable in any manner that allows exterior door 296 to open and close carbonation source inlet 292. For example, exterior door 296 may rotate, translate, or both between the open position (FIG. 23) and the closed position (FIG. 24). In the example shown, exterior door 296 is pivotably openable by a hinge 396.

In some examples, exterior door 296 may be inhibited from re-opening by a door lock 404. This may prevent a user and/or system gas pressure (e.g., within carbonation chamber 140) from forcing exterior door 296 open during carbonation and/or evacuation operations. Door lock 404 may be movable from a locked position in which door lock 404 inhibits exterior door 296 from opening, and an unlocked position in which door lock 404 is disengaged (i.e., does not impede exterior door 296 from opening). Door lock 404 can have any configuration suitable to inhibit exterior door 296 from opening when in the locked position. In the example shown, door lock 404 comprises a latch bolt 408 that extends into a lock recess 412 (FIG. 18) in the locked position and retracts from the lock recess 412 in the unlocked position.

Reference is now made to FIG. 19. After depositing carbonation packet 500, engaging beverage container 108 with beverage carbonator 104, and closing carbonation source inlet 292, beverage carbonation system 100 (FIG. 2) may begin a carbonation operation. The carbonation operation may be started in any suitable manner. For example, the carbonation operation may begin automatically upon moving container engagement actuator 176 to the container engaged position. In some examples, moving lever 180 to the container engaged position signals electronic controller 388 (FIG. 5) to begin the carbonation operation. In the example shown, a user may interact with (e.g., make a user-selection using) one or more user inputs 416 (FIG. 2) or may send control signals to the electronic controller 388 directly or by way of the server computer 622 (FIG. 5). For example, user inputs 416 may comprise a “START” button, which may be activated to trigger controller 388 (FIG. 5) to execute the carbonation operation. Optionally, user inputs 416 may permit the user to configure one or more parameters of the carbonation operation, such as for example desired carbonation level (e.g., corresponding to a duration of the gas recirculation state).

FIG. 19 illustrates carbonation chamber 140 when in the reservoir draw state (described above in connection with FIG. 10). As shown, water 146 is pumped into carbonation chamber 140 through fluid inlet 204 and begins pooling within chamber housing 288. Water 146 contacts carbonation packet 500 and starts dissolving packet body 504 to release granular carbonate material 512, granular acid material 516, and granular desiccant material 520 from single compartment 508. Granular carbonate material 512 begins reacting with granular acid material 516 to generate carbon dioxide gas 168 once a water retention capacity of the granular desiccant material 520 is surpassed by the water 146. In some examples, granular desiccant material may also begin reacting with granular carbonate material 512 and/or granular acid material 516 to generate carbon dioxide gas 168. Packet body 504 is shown partially dissolved in FIG. 19.

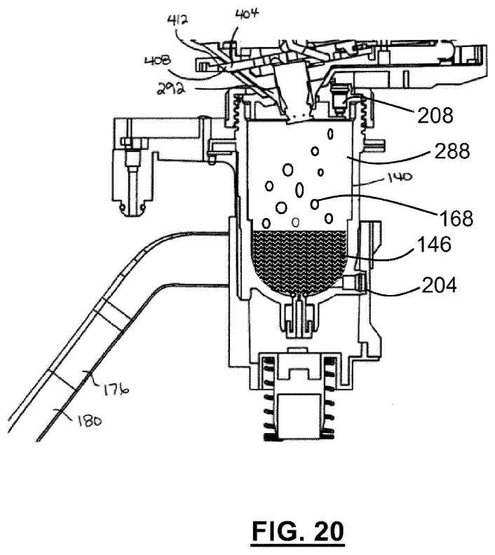

FIG. 20 illustrates carbonation chamber 140 at the start of the gas recirculation state (described above in connection with FIG. 11). Compared with FIG. 19, water 146 has risen within chamber housing 288 and packet body 504 is fully dissolved. The system gas pressure (e.g., within carbonation chamber 140 or elsewhere) may exceed the predetermined threshold, whereby pump 148 has been fluidly disconnected from water reservoir 144 and instead fluidly connected to carbonator inlet 132 (FIG. 11). Carbon dioxide gas 168 continues to be generated by yet unreacted granular carbonate material 512 and granular acid material 516 (i.e., carbon dioxide generating material that has not completely reacted), and is recirculated continuously through beverage container 108. The duration of the recirculation state may determine the degree of carbonation of the resulting beverage, and in some examples this duration is determined by the electronic controller 388 (FIG. 5) based at least in part on user selections made with user input(s) 416 (FIG. 1), a program stored in memory 602 or memory 626, and/or control signals received from portable electronic device 620 or server computer 622 (FIG. 5).

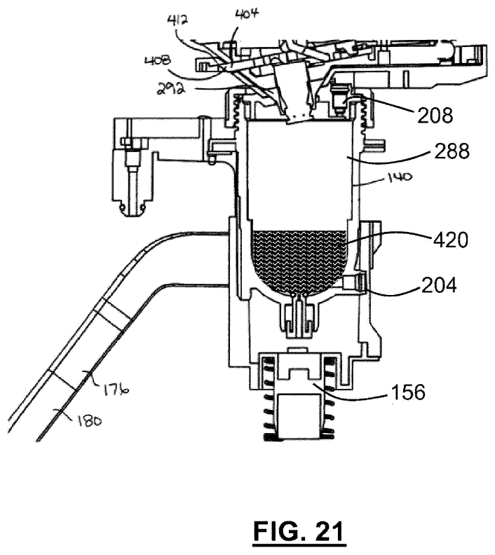

FIG. 21 illustrates carbonation chamber 140 at the moment the gas recirculation state is terminated. As shown, the reaction in the aqueous mixture of granular carbonate material, granular acid material, and water has completed, leaving only byproduct waste 420 behind. Dissolved packet body 504 makes up part of this waste byproduct 420. Byproduct outlet 156 is shown in a closed position. In the example shown, container engagement actuator 176 is still in the container engaged position as shown in FIG. 24.

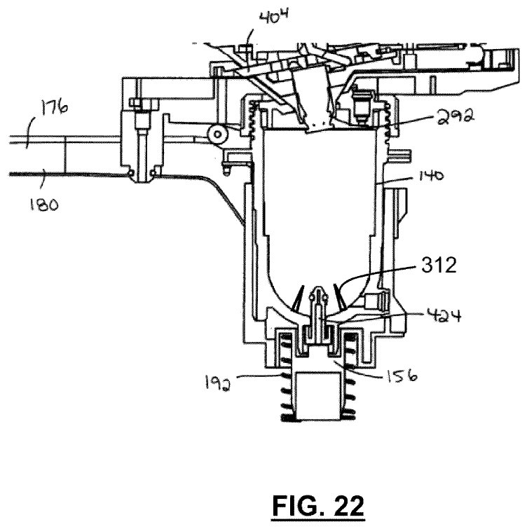

FIG. 22 illustrates carbonation chamber 140 after above-atmospheric gas pressure is trapped within carbonation chamber 140, and byproduct outlet 156 is opened whereby waste byproduct in carbonation chamber 140 is evacuated through byproduct outlet 156 into byproduct waste container 160 (FIG. 12). For example, a pressure difference between the above-atmospheric carbonation chamber 140 and the atmospheric byproduct waste container 160 (FIG. 12) may result in the contents of carbonation chamber 140 exiting rapidly through byproduct outlet 156 into byproduct waste container 160 when byproduct outlet 156 is opened.

Byproduct outlet 156 may be configured to be openable in any manner. In the example shown, byproduct outlet 156 comprises a byproduct outlet valve 424. As shown, byproduct outlet valve 424 may remain in the closed position during the reservoir draw state and gas recirculation state, and may be opened after sealing above-atmospheric system gas pressure within at least carbonation chamber 140 to evacuate carbonation chamber 140 of byproduct waste 420. Byproduct outlet valve 424 may be moved between the open and closed position in any manner. For example, byproduct outlet valve 424 may be electronically actuated by electronic controller 388 (FIG. 5), or mechanically actuated (e.g., manually by the user, or automatically by an interaction with other system components). In the example shown, byproduct outlet valve 424 is biased to the closed position (e.g., by a valve bias 192), and opens automatically upon moving container engagement actuator 176 to the disengaged position (e.g., raising lever 180 to disengage the beverage container).

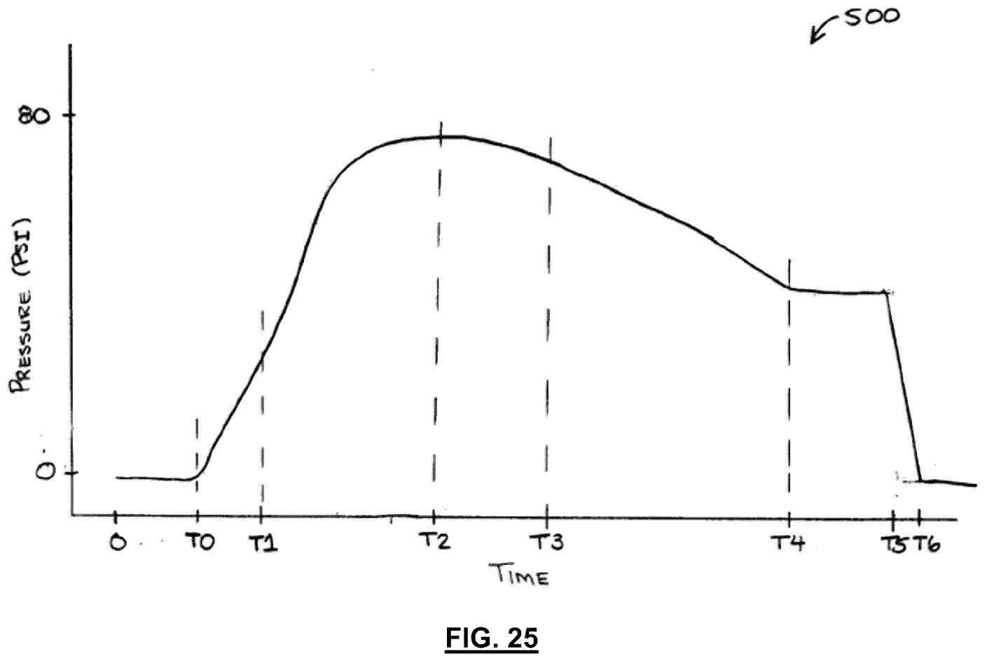

FIG. 25 depicts a pressure curve 900 showing a system gas pressure within beverage carbonator 104 during a carbonation operation, in accordance with an embodiment. The plotted time and pressure values shown are examples. Other embodiments may produce a different curve. The general shape of curve 900 may apply to many embodiments. The pressure values shown are gage pressures, where 0 psi means 0 psi above atmospheric pressure.

Referring to FIGS. 10 and 19, at time TO beverage carbonation system 100 is in a reservoir draw state and the reaction in the aqueous mixture of water 146, granular carbonate material 512, granular acid material 516, and granular desiccant material 520 has just begun. The system gas pressure within beverage carbonator 104 rises to the predetermined threshold for flow valve 152 at T1. Thus, at T1 beverage carbonation system 100 changes to the gas recirculation state. Hereafter, beginning at T1, system gas pressure is (i) increased by carbon dioxide gas generation inside carbonation chamber 140 and (ii) decreased by carbon dioxide gas absorption by beverage 112.

At T2, the system gas pressure peaks and then begins to fall, which illustrates that the rate of carbon dioxide absorption equals and then begins to exceed the rate of carbon dioxide generation. This happens as a result of the unreacted carbon dioxide generating material (e.g., sodium bicarbonate and citric acid) within carbonation chamber 140 beginning to deplete.

At T3, all of the carbon dioxide generating material has been fully reacted and no further carbon dioxide gas is generated. The loss of system gas pressure is a result of carbon dioxide gas absorption into beverage 112.

At T4, beverage carbonation system 100 is in a container sealed state, and the remaining system gas pressure is retained in at least carbonation chamber 140.

At T5, byproduct outlet 156 is opened, and the system gas pressure is vented through byproduct outlet 156 to evacuate carbonation chamber 140 into byproduct waste container 160.

At T6, evacuation of byproduct waste container 160 is completed and the system gas pressure is at atmospheric pressure. Byproduct waste container 160 may be removed from beverage carbonator 104 and emptied (e.g., in a byproduct bin or sink) and then reconnected to beverage carbonator 104.

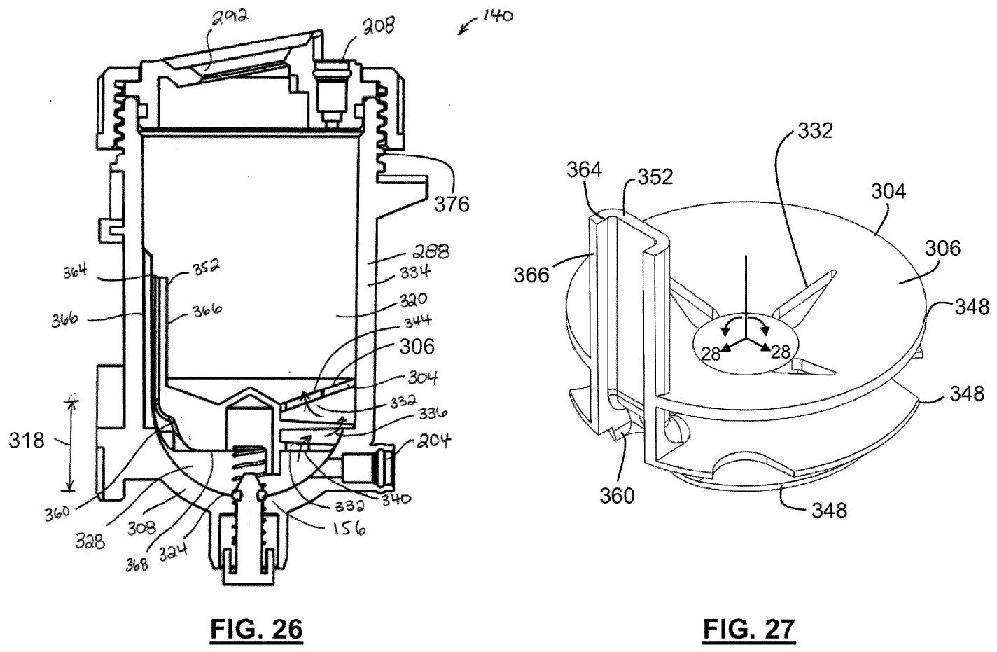

FIG. 26 shows example carbonation chamber 140 that may be used in beverage carbonator 104 of FIGS. 1-4. The carbonation chamber 140 shown in FIG. 26 is similar to the carbonation chamber shown in FIG. 14 except for the difference described below and the omission of piercers 312. Unless otherwise noted, like-numbered elements have similar structure and/or perform similar function as those in the carbonation chamber 140 in FIG. 14.

In the example shown, carbonation chamber 140 comprises a carbonation source carrier 304 (e.g., platform, plate, table, or tray) located within chamber housing 288. Carbonation source carrier 304 may hold carbon dioxide generating material at an elevation above chamber lower end 308 so the carbon dioxide generating material does not enter an aqueous mixture that generates carbon dioxide until the water level within chamber housing 288 rises to the carbonation source carrier 304.

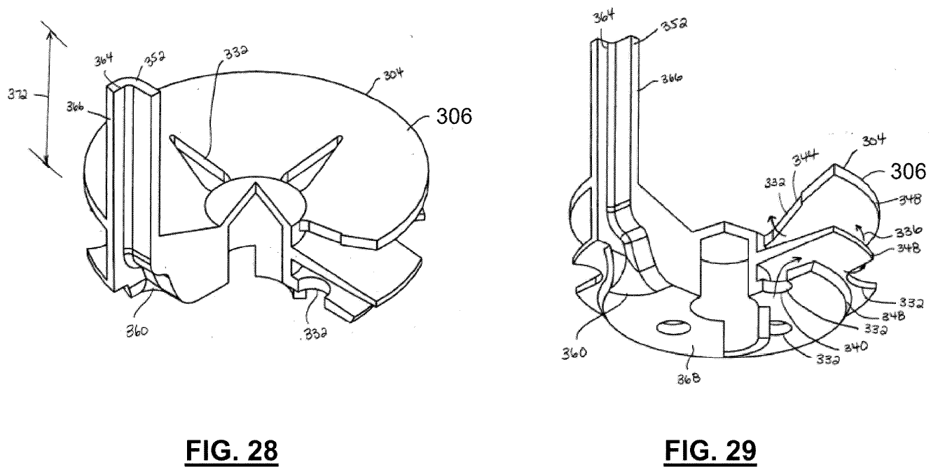

Reference is now made to FIGS. 26-29. As shown, carbonation source carrier 304 may comprise a carrier surface 306 that holds carbon dioxide generating material prior to mixing with water. For example, carrier surface 306 may be an upwardly facing surface. Carrier surface 306 may define an upper surface of carbonation source carrier 304. In the example shown, carrier surface 306 is aligned with (e.g., vertically aligned with) carbonation source inlet 292. This allows carbon dioxide generating material deposited through carbonation source inlet 292 to (e.g., fall by gravity) and collect on carrier surface 306. In the example shown, carrier surface 306 is located at an elevation 318 above a lower end 324 of chamber inner volume 320. For example, an open portion 328 (i.e., where water can pool) of chamber inner volume 320 is located at an elevation below carrier surface 306, and may be equal to or greater than the predetermined minimum volume (e.g., at least 50 mL). Elevation 318 may be any corresponding distance, such as for example at least 5 mm, such as 5-100 mm. Open portion 328 may also be referred to herein as a “lower region” or “first region” of chamber inner volume 320.

Still referring to FIGS. 26-29, carbonation chamber fluid inlet 204 may be located anywhere relative to chamber housing 288 that allows liquid entering through fluid inlet 204 to pool prior to contacting the carbonation source (e.g., located on carrier surface 306). For example, fluid inlet 204 may be located below carrier surface 306 as shown so that the liquid is below carrier surface 306 from the moment of entering chamber housing 288. This may help prevent the entering liquid from inadvertently spraying onto carrier surface 306 upon entry into chamber housing 288. In turn, this may mitigate premature carbon dioxide generation, which may prematurely raise the system gas pressure, and consequently prematurely toggle the flow valve to fluidly disconnect the pump from the liquid reservoir before sufficient liquid for a complete reaction of carbonation source has been delivered to the carbonation chamber.

In other examples, fluid inlet 204 may be located above carrier surface 306, and oriented to direct the entering water to flow into the open portion 328 of chamber inner volume 320. An advantage of this design is that it can provide more flexibility in the positioning of fluid inlet 204, which may ultimately allow beverage carbonator 104 (FIG. 1) to accommodate a more compact arrangement of internal components. In turn, this may allow beverage carbonation system 100 (FIG. 3) to have a smaller overall form factor, which may be appreciated by users with limited counter space.

In some examples, carbonation source carrier 304 is formed essentially of a plate supported above chamber lower end 308 (e.g., by stand-offs). In some examples, carrier surface 306 may comprise one or more fluid openings 332 that allow water that has pooled in chamber housing 288 to flow onto carrier surface 306 and mix with the carbon dioxide generating materials supported thereon. Fluid openings 332 may be inset from a perimeter of carrier surface 306 as shown (i.e., may be surrounded by carrier surface 306) or may border carrier surface 306 (e.g., may be bordered by carrier surface 306 and chamber housing sidewall 334).

In some examples, fluid openings 332 may provide a passage for reaction byproduct to move from carrier surface 306 to byproduct outlet 156 when carbonation chamber 140 is evacuated. For example, byproduct outlet 156 may be located below carrier surface 306 (e.g., at lower end 324). In the example shown, byproduct outlet 156 borders open lower volume 328, such that fluid openings 332 accommodate both upwardly flow of liquid from lower volume 328, and a downwardly flow of reaction byproduct towards lower volume 328. In alternative examples, carrier surface 306 does not have any fluid openings 332. Instead, accumulated water may flow onto carrier surface 306 in a different manner (e.g., pour from above).

Still referring to FIGS. 26-29, in some examples, carbonation source carrier 304 may comprise a non-linear liquid flow path 336 extending from a liquid inlet 340 to a liquid outlet 344. The liquid flow path 336 may define the path that liquid must follow to reach carrier surface 306. For example, chamber fluid inlet 204 may be fluidly connected to carrier surface 306 only by liquid flow path 336. This may help mitigate instances of liquid splashing onto carrier surface 306 upon entering chamber housing 288, and causing premature reactions. In some examples, liquid flow path 336 provides, in the reverse direction (i.e., from outlet 344 to inlet 340) a path for byproduct waste to flow to byproduct outlet 156. Moreover, non-linear liquid flow path 336 may prevent or reduce instances (or the quantity) of carbon dioxide generating material falling from carrier surface 306 to below carbonation source carrier 304, and reacting prematurely.

Liquid flow path 336 may be formed in any manner that mitigates liquid splashing onto carrier surface 306 upon entering chamber housing 288, and/or which provides an exit path for byproduct waste to byproduct outlet 156, and/or mitigates carbon dioxide generating material falling to below carbonation source carrier 304 and reacting prematurely. In the embodiment shown, carbonation source carrier 304 comprises a plurality of spaced apart floors 348. The top floor 348 may comprise carrier surface 306. As shown, each floor may comprise one or more fluid openings 332. In this example, opening(s) 332 in the top floor 348 may define a flow path outlet 344, and opening(s) 332 in bottom floor 348 may define a flow path inlet 340. As shown, openings 332 of adjacent floors 348 may be staggered (i.e., vertically misaligned) so that the resulting flow path 336 is non-linear (e.g., tortuous). This may help mitigate liquid splashing onto carrier surface 306 upon entering chamber housing 288. This may also help mitigate carbon dioxide generating material falling to below carbonation source carrier 304 and mixing with water prematurely. For example, the offset openings 332 may generally limit carbon dioxide generating material that falls through an opening 332 in carrier surface 306 to falling only one floor 348 below.

Carbonation source carrier 304 may comprise any number of floors 348, and each floor can have any number of openings 332 of any size suitable to provide a non-linear flow path 336 that mitigates one or more of the issues noted above. For example, carbonation source carrier 304 may comprise at least two floors 348 (e.g., 2 to 20 floors 348), and each floor may have at least one opening 332 (e.g., 1-20 openings 332). In the example shown, there are three floors 348, each of which has three openings 332. In alternative examples, carbonation source carrier 304 does not have a plurality of floors 348. This may provide a design for carbonation source carrier 304 that is less complex and expensive to manufacture.

Still referring to FIGS. 26-29, carbonation chamber fluid inlet 204 may admit carbon dioxide gas into carbonation chamber 140 (e.g., during a gas recirculation system state, FIG. 5). The gas may enter chamber housing 288 at fluid inlet 204 and exit through gas outlet 208. In some examples, the gas flow from fluid inlet 204 to gas outlet 208 may help to agitate the mixture of water and carbon dioxide generating material to promote a complete reaction (i.e., leaving no unreacted carbon dioxide generating material). For example, gas entering at fluid inlet 204 may bubble up through the liquid along a path crossing carrier surface 306 before exiting gas outlet 208. This may agitate any remaining carbon dioxide generating material that has not completely reacted to mix with the liquid and produce carbon dioxide gas. In some examples, carbonation chamber 140 may comprise a fluid flow path 336, and some or all gas entering at fluid inlet 204 may travel along fluid flow path 336 from path inlet 340 to path outlet 344 across carrier surface 306 before exiting through gas outlet 208.

Aside from carbon dioxide gas, the byproduct of the reaction between the carbonation source and liquid is referred to herein as byproduct or reaction byproduct (also referred to as liquid byproduct if it has a liquid form). The byproduct may have a viscosity greater than water (e.g., a paste-like consistency) or a viscosity equal to or less than water. In some cases, the byproduct may prevent or hinder (e.g., slow) liquid from traveling through fluid flow path 336 into contact with unreacted carbonation source on carrier surface 306. For example, the generated byproduct may clog fluid flow path 336 during a carbonation operation. This may also prevent or hinder gas from flowing through fluid flow path 336 across carrier surface 306 to agitate the aqueous mixture of incompletely reacted carbonation source and liquid.

In some examples, chamber housing 288 may comprise a recirculation conduit 352 that bypasses fluid flow path 336. Recirculation conduit 352 may provide a passage for fluid when, for example fluid flow path 336 is partially or completely obstructed. As shown, recirculation conduit 352 (also referred to as bypass conduit 352) may extend from a conduit inlet 360 to a conduit outlet 364. Conduit inlet 360 may be located proximate chamber lower end 308 (or at least closer to chamber lower end 308 than conduit outlet 364). For example, conduit inlet 360 may be located at or below carrier lower end 368 as shown. Conduit outlet 364 is located above conduit inlet 360. For example, conduit outlet 364 may be located above a liquid level inside chamber housing 288. This may reduce the possibility that byproduct formed in chamber housing 288 will flow into recirculation conduit 352. In the example shown, conduit outlet 364 is located above carrier surface 306. For example, an elevation separation 372 between carrier surface 306 and conduit outlet 364 may be at least 5 mm (e.g., between 5 mm and 100 mm). Such separation distance 372 may prevent or reduce byproduct splashing into conduit outlet 364, and may accommodate variation in the liquid level. Other separation distances 372 may be used depending on the context.

In use, gas entering fluid inlet 204 may flow up through recirculation conduit 352 and exit through gas outlet 208. As shown, gas outlet 208 may be located above carrier surface 306, such as at or proximate chamber housing upper end 376. When gas flows through recirculation conduit 352, the gas may drive/carry with it liquid. The entrained liquid may exit conduit outlet 364 and then fall by gravity onto carrier surface 306. Thus, recirculation conduit 352 may also help move liquid to carrier surface 306 to react with incompletely reacted carbon dioxide generating material.

Still referring to FIGS. 26-29, recirculation conduit 352 may be formed in any manner suitable to allow gas entering carbonation chamber 140 to bypass carrier surface 306. For example, recirculation conduit 352 may be formed by chamber housing 288 (e.g., by chamber housing sidewall 334), by carbonation source carrier 304, or by a discrete member (e.g., conduit extending between chamber housing sidewall 334 and carbonation source carrier 304). In the example shown, recirculation conduit 352 comprises conduit sidewalls 366 formed collectively by carbonation source carrier 304 and chamber housing sidewall 334. As shown, recirculation conduit 352 may extend (e.g., be located) laterally outboard of carrier surface 306. In alternative examples, recirculation conduit 352 may extend through carrier surface 306 (e.g., centrally through carrier surface 306).

In various examples, carbonation chamber 140 may comprise fluid flow path 336, or recirculation conduit 352, or both (as shown), or neither. In some examples, carbonation chamber 140 may comprise a gas inlet separate from fluid inlet 204. The discrete gas inlet may be located above, below, or level with carrier surface 306. As an example, beverage carbonation system 100 may comprise a separate gas recirculation pump to recirculate gas from carbonator inlet 132 to carbonator outlet 128 across carbonation chamber 140 (FIG. 11).

Reference is now made to FIGS. 30-37, which illustrate steps in the operation of the carbonation chamber 140 of FIGS. 26-29. FIG. 30 shows carbonation chamber 140 when in the container disengaged position, with exterior door 296 open to allow carbon dioxide generating material 164 to be poured through carbonation source inlet 292. Carbonation packet 500 of FIGS. 7A-7C is shown open at one end to allow carbon dioxide generating material 164 and granular desiccant material 520 to be poured out of the single compartment 508 and through the carbonation source inlet 292. As described above, the carbon dioxide generating material 164 (e.g., granular carbonate material 512 and granular acid material 516 as shown in FIG. 7C) is sealed together with granular desiccant material 520 in the single compartment 508 of carbonation packet 500.

FIG. 31 shows carbonation chamber 140 after carbon dioxide generating material 164 has been deposited into carbonation chamber 140 through the opened carbonation source inlet 292. As compared with FIG. 30, carbon dioxide generating material 164 and granular desiccant material 520 is seen carried on (e.g., piled onto or mounded on) carrier surface 306. For example, carbon dioxide generating material 164 and granular desiccant material 520 may have fallen by gravity from carbonation source inlet 292 onto carrier surface 306.

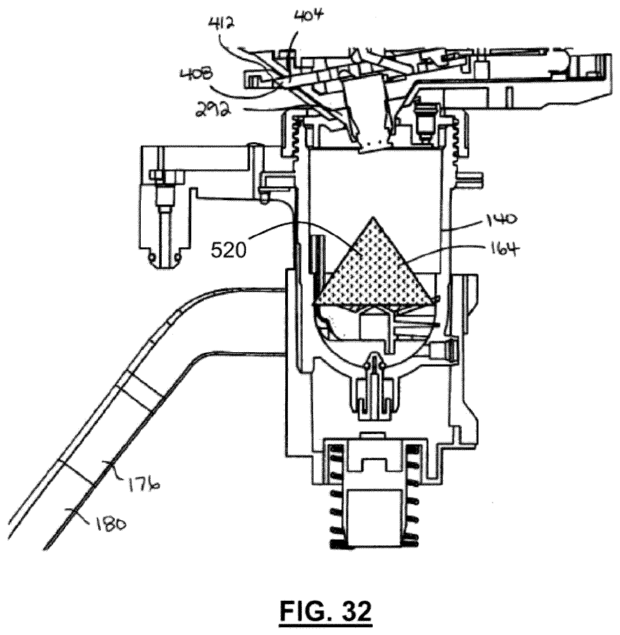

FIG. 32 shows carbonation chamber 140 after exterior door 296 (FIG. 24) is closed to seal carbonation source inlet 292. As shown, container engagement actuator 176 is in the engaged position (e.g., lever 180 is fully lowered by the user). In the example shown, moving container engagement actuator 176 to the engaged position causes exterior door 296 to close. This may prevent a user from accidentally leaving exterior door 296 open when a carbonation operation is activated.

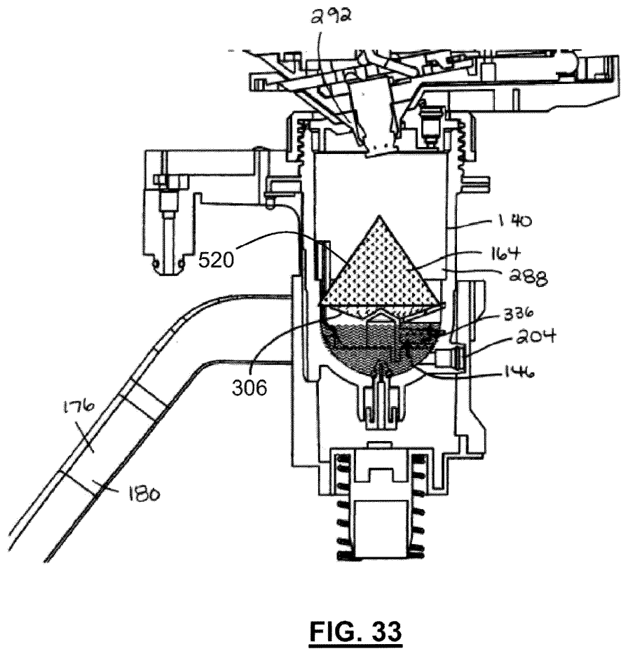

Reference is now made to FIG. 33. After depositing carbon dioxide generating material 164, engaging the beverage container 108 with the beverage carbonator 104, and closing carbonation source inlet 292, beverage carbonation system 100 (FIG. 2) may begin the carbonation operation. The carbonation operation may be started in any suitable manner. For example, the carbonation operation may begin automatically upon moving container engagement actuator 176 to the container engaged position. In some examples, moving lever 180 to the container engaged position signals electronic controller 388 (FIG. 5) to begin the carbonation operation.

In the example shown, a user may interact with (e.g., make a user-selection using) one or more user inputs 416 (FIG. 2) or may send control signals to the electronic controller 388 directly or by way of the server computer 622 (FIG. 5). For example, user inputs 416 may comprise a “START” button, which may be activated to trigger controller 388 (FIG. 5) to execute the carbonation operation. Optionally, user inputs 416 may permit the user to configure one or more parameters of the carbonation operation, such as for example desired carbonation level (e.g., corresponding to a duration of the gas recirculation state).

FIG. 33 illustrates carbonation chamber 140 when in the reservoir draw state (described above in connection with FIG. 10). As shown, water 146 is pumped into carbonation chamber 140 through fluid inlet 204 and begins pooling within chamber housing 288 prior to making contact with carbon dioxide generating material 164. In the example shown, water 146 is shown rising upwardly through fluid flow path 336 towards carrier surface 306.

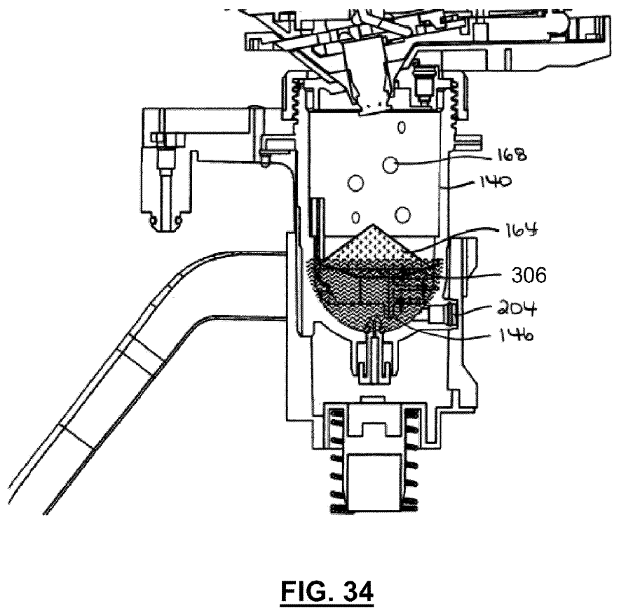

FIG. 34 illustrates carbonation chamber 140 at the start of the gas recirculation state (described above in connection with FIG. 11). As shown, water 146 has risen above carrier surface 306 and carbon dioxide gas 168 production is well underway. Carbon dioxide generating material 164 (e.g., citric acid and sodium bicarbonate) begins reacting to generate carbon dioxide gas 168 once a water retention capacity of the granular desiccant material 520 is surpassed by the water 146. In some examples, granular desiccant material may also begin reacting with carbon dioxide generating material 164 to generate carbon dioxide gas 168. The system gas pressure (e.g., within carbonation chamber 140 or elsewhere) may exceed the predetermined threshold, whereby pump 148 has been fluidly disconnected from water reservoir 144 and instead fluidly connected to the carbonator inlet 132 (FIG. 11).

Carbon dioxide gas 168 continues to be generated by yet unreacted carbon dioxide generating material 164 (i.e., carbon dioxide generating material 164 that has not completely reacted) and is recirculated continuously through the beverage container 108. The duration of the recirculation state may determine the degree of carbonation of the resulting beverage, and in some examples this duration is determined by the electronic controller 388 (FIG. 5) based at least in part on user selections made with user input(s) 416 (FIG. 1), a program stored in memory 602 or memory 626, and/or control signals received from portable electronic device 620 or server computer 622 (FIG. 5).

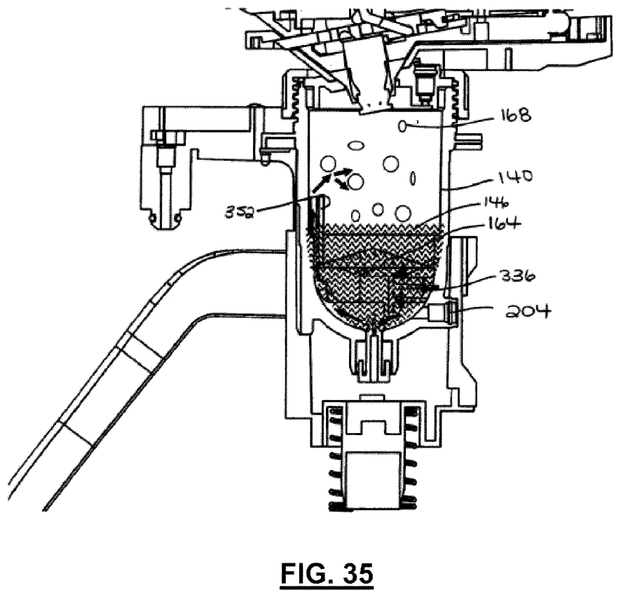

FIG. 35 illustrates carbonation chamber 140 part way through the duration of the gas recirculation state (described above in connection with FIG. 11). As shown, gas entering carbonation chamber 140 through fluid inlet 204 may bubble up through flow path 336 as well as recirculation conduit 352 to promote rapid mixing of carbon dioxide generating material 164 and liquid 146.

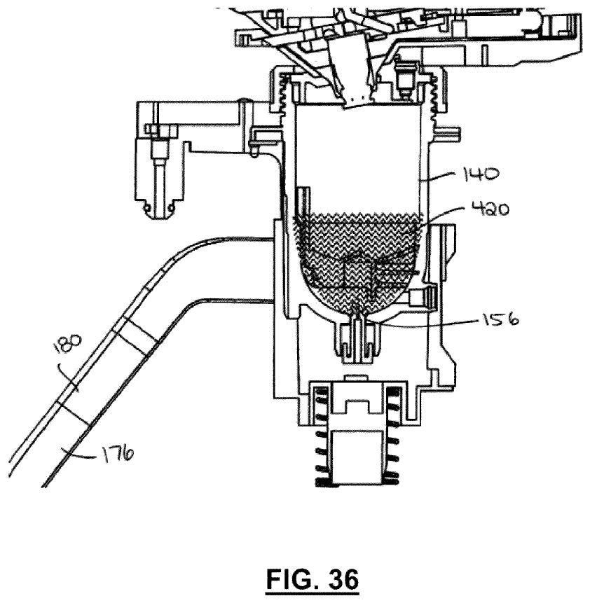

FIG. 36 illustrates carbonation chamber 140 at the moment the gas recirculation state is terminated. As shown, the reaction in the aqueous mixture of carbon dioxide generating material and liquid has completed, leaving only liquid waste byproduct 420 behind. Byproduct outlet 156 is shown in a closed position. In the example shown, container engagement actuator 176 is still in the engaged position as shown in FIG. 24.

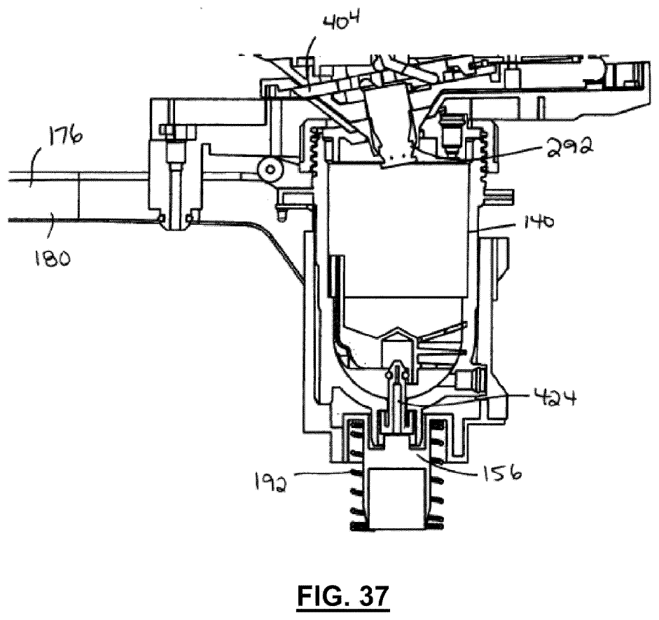

FIG. 37 illustrates carbonation chamber 140 after above-atmospheric gas pressure is trapped within carbonation chamber 140, and byproduct outlet 156 is opened whereby liquid byproduct waste in carbonation chamber 140 is evacuated through byproduct outlet 156 into byproduct waste container 160 (FIG. 12). For example, a pressure difference between the above-atmospheric carbonation chamber 140 and the atmospheric byproduct waste container 160 (FIG. 6) may result in the contents of carbonation chamber 140 exiting rapidly through byproduct outlet 156 into byproduct waste container 160 (FIG. 6) when byproduct outlet 156 is opened.

While the above description provides examples of one or more apparatuses or methods, it will be appreciated that other apparatuses or methods may be within the scope of the accompanying claims.

### Items

Item 1: A carbonation packet for depositing carbon dioxide generating material into a carbonation chamber of a beverage carbonator, the carbonation packet comprising:
a packet body defining a single compartment;
a granular carbonate material sealed within the single compartment, the granular carbonate material being water-dissolvable;
a granular acid material sealed within the single compartment, the granular acid material being water-dissolvable; and
a granular desiccant material sealed within the single compartment to prevent the granular carbonate material from reacting with the granular acid material while sealed in the single compartment, the granular desiccant material being water-dissolvable.

Item 2: The carbonation packet of any preceding item, wherein the granular desiccant material prevents the granular carbonate material from reacting with the granular acid material while sealed in the single compartment by absorbing moisture.

Item 3: The carbonation packet of any preceding item, wherein the granular desiccant material delays the granular carbonate material from reacting with the granular acid material until a water retention capacity of the granular desiccant material is surpassed.

Item 4: The carbonation packet of any preceding item, wherein, once the water retention capacity of the granular desiccant material is surpassed, the granular carbonate material is reactive with the granular acid material in water to generate carbon dioxide gas.

Item 5: The carbonation packet of any preceding item, wherein, once the water retention capacity of the granular desiccant material is surpassed, the granular carbonate material, the granular acid material and the granular desiccant material are reactive in water to generate carbon dioxide gas and a disposable liquid byproduct.

Item 6: The carbonation packet of any preceding item, wherein the granular carbonate material, the granular acid material, and the granular desiccant material are mixed within the single compartment.

Item 7: The carbonation packet of any preceding item, wherein the granular carbonate material, the granular acid material and the granular desiccant material are homogenously mixed within the single compartment.

Item 8: The carbonation packet of any preceding item, wherein the granular desiccant material comprises MgSO₄ (anhydrous).

Item 9: The carbonation packet of any preceding item, wherein a mass ratio of the granular acid material to the granular desiccant material is between approximately 2:1 and 7:1.

Item 10: The carbonation packet of any preceding item, wherein a mass ratio of the granular carbonate material to the granular desiccant material is between approximately 4:1 and 8:1.

Item 11: The carbonation packet of any preceding item, wherein the granular desiccant material has a mass of between approximately 1.5 and 4 grams.

Item 12: The carbonation packet of any preceding item, wherein the granular carbonate material, the granular acid material, and the granular desiccant material have a collective mass of between approximately 15 and 40 grams.

Item 13: The carbonation packet of any preceding item, wherein the packet body is at least partially dissolvable in the water to release the granular carbonate material, the granular acid material, and the granular desiccant material from the single compartment.

Item 14: The carbonation packet of any preceding item, wherein the packet body is at least partially made of a water-soluble synthetic polymer.

Item 15: The carbonation packet of any preceding item, wherein the packet body is flexible and rapidly water-dissolvable.

Item 16: The carbonation packet of any preceding item, wherein the packet body is at least 50% dissolved when exposed to water for 15 minutes.

Item 17: The carbonation packet of any preceding item, wherein the single compartment is at least partially openable to release the granular carbonate material, the granular acid material, and the granular desiccant material therefrom.

Item 18: The carbonation packet of any preceding item, wherein the packet body comprises a tear tab for opening the single compartment.

Item 19: The carbonation packet of any preceding item, wherein the packet body is made of a compostable material.

Item 20: The carbonation packet of any preceding item, wherein the packet body is at least partially made of a plant-based material.

Item 21: The carbonation packet of any preceding item, wherein the packet body is at least partially made of polypropylene.

Item 22: The carbonation packet of any preceding item, wherein the granular acid material comprises a carboxylic acid.

Item 23: The carbonation packet of any preceding item, wherein the carboxylic acid is citric acid.

Item 24: The carbonation packet of any preceding item, wherein the granular carbonate material comprises sodium bicarbonate.

Item 25: A retail package comprising a plurality of the carbonation packets of any preceding item, wherein each carbonation packet of the plurality of carbonation packets comprises a quantity of the granular carbonate material, a quantity of the granular acid material, and a quantity of the granular desiccant material, the quantity of the granular carbonate material being equal for each carbonation packet of the plurality of carbonation packets, the quantity of the granular acid material being equal for each carbonation packet of the plurality of carbonation packets, and the quantity of the granular desiccant material being equal for each carbonation packet of the plurality of carbonation packets.

Item 26: A beverage carbonation system comprising:
a carbonation packet comprising:
   a packet body that is flexible and rapidly water-dissolvable, the packet body defining a single compartment;
   a granular carbonate material sealed within the single compartment, the granular carbonate material being water-dissolvable;
   a granular acid material sealed within the single compartment, the granular acid material being water-dissolvable, the granular carbonate material being reactive with the granular acid material in water to generate carbon dioxide gas; and
   a granular desiccant material sealed within the single compartment, the granular desiccant material being water-dissolvable; and
a beverage carbonator comprising:
   a carbonation chamber having a carbonation source inlet, a fluid inlet, a gas outlet, and a carbonation source carrier, the carbonation source carrier being positioned to receive the carbonation packet deposited into the carbonation chamber through the carbonation source inlet, the carbonation source carrier and the fluid inlet being arranged to expose the carbonation packet to water introduced into the carbonation chamber through the fluid inlet.

Item 27: The beverage carbonation system of any preceding item, wherein the granular desiccant material prevents the granular carbonate material from reacting with the granular acid material while sealed in the single compartment by absorbing moisture.

Item 28: The beverage carbonation system of any preceding item, wherein the granular desiccant material delays the granular carbonate material from reacting with the granular acid material until a water retention capacity of the granular desiccant material is surpassed.

Item 29: The beverage carbonation system of any preceding item, wherein the gas outlet provides an exit for carbon dioxide gas generated in the carbonation chamber.

Item 30: The beverage carbonation system of any preceding item, wherein the packet body is dissolvable in water to release the granular carbonate material, the granular acid material, and the granular desiccant material from the single compartment.

Item 31: The beverage carbonation system of any preceding item, wherein the packet body is at least 50% dissolved when exposed to water for 15 minutes.

Item 32: The beverage carbonation system of any preceding item, wherein the carbonation chamber comprises a byproduct outlet, the byproduct outlet being openable to provide an exit for a disposable liquid byproduct from the carbonation chamber.

Item 33: The beverage carbonation system of any preceding item, wherein the granular carbonate material, the granular acid material and the granular desiccant material are mixed within the single compartment.

Item 34: The beverage carbonation system of any preceding item, wherein the granular desiccant material comprises MgSO₄ (anhydrous).

Item 35: A beverage carbonation system comprising:
a carbonation packet comprising:
   a packet body defining a single compartment;
   a granular carbonate material sealed within the single compartment, the granular carbonate material being water-dissolvable;
   a granular acid material sealed within the single compartment, the granular acid material being water-dissolvable, the granular carbonate material being reactive with the granular acid material in water to generate carbon dioxide gas; and
   a granular desiccant material sealed within the single compartment, the granular desiccant material being water-dissolvable, wherein the single compartment is at least partially openable to release the granular carbonate material, the granular acid material, and the granular desiccant material therefrom; and
a beverage carbonator comprising:
   a carbonation chamber having a carbonation source inlet, a fluid inlet, a gas outlet, and a carbonation source carrier, the carbonation source carrier being positioned to receive the granular carbonate material, the granular acid material and the granular desiccant material deposited into the carbonation chamber through the carbonation source inlet, the carbonation source carrier and the fluid inlet being arranged to expose the granular carbonate material, the granular acid material and the granular desiccant material to water introduced into the carbonation chamber through the fluid inlet.

Item 36: The beverage carbonation system of any preceding item, wherein the granular desiccant material prevents the granular carbonate material from reacting with the granular acid material while sealed in the single compartment by absorbing moisture.

Item 37: The beverage carbonation system of any preceding item, wherein the granular desiccant material delays the granular carbonate material from reacting with the granular acid material until a water retention capacity of the granular desiccant material is surpassed.

Item 38: The beverage carbonation system of any preceding item, wherein the gas outlet provides an exit for carbon dioxide gas generated in the carbonation chamber.

Item 39: The beverage carbonation system of any preceding item, wherein the carbonation chamber comprises a byproduct outlet, the byproduct outlet being openable to provide an exit for a disposable liquid byproduct from the carbonation chamber.

Item 40: The beverage carbonation system of any preceding item, wherein the packet body comprises a tear tab for opening the single compartment.

Item 41: The beverage carbonation system of any preceding item, wherein the carbonation source carrier and fluid inlet are arranged to hold the granular carbonate material, the granular acid material and the granular desiccant material deposited on the carbonation source carrier apart from the water admitted into the carbonation chamber through the fluid inlet until a predetermined volume of water has accumulated in the carbonation chamber.

Item 41: The beverage carbonation system of any preceding item, wherein the predetermined volume is at least 50 mL.

Item 42: The beverage carbonation system of any preceding item, wherein the granular desiccant material comprises MgSO₄ (anhydrous).

Item 43. A method of generating carbon dioxide gas for a beverage, the method comprising:
simultaneously receiving a granular carbonate material, a granular acid material and a granular desiccant material by a carbonation chamber;
receiving a volume of water into the carbonation chamber, the received volume of water exceeding a water retention capacity of the granular desiccant material; and
generating carbon dioxide gas from a reaction between at least the granular carbonate material and the granular acid material.

Item 44: The method of any preceding item, wherein said generating the carbon dioxide gas comprises:
mixing the granular carbonate material, the granular acid material, and the granular desiccant material with the volume of water received into the carbonation chamber.

Item 45: The method of any preceding item, wherein said generating the carbon dioxide gas comprises:
generating the carbon dioxide gas from the reaction between the granular carbonate material, the granular acid material, and the granular desiccant material.

Item 46: The method of any preceding item, wherein said simultaneously receiving comprises:
receiving a carbonation packet by the carbonation chamber, the carbonation packet having a dissolvable packet body that is flexible and rapidly water-dissolvable, the dissolvable packet body defining a single compartment that seals the granular carbonate material, the granular acid material, and the granular desiccant material.

Item 47: The method of any preceding item, further comprising:
at least partially dissolving the dissolvable packet body with the volume of water received into the carbonation chamber to release the granular carbonate material, the granular acid material, and the granular desiccant material from the single compartment.

Item 48: The method of any preceding item, wherein said receiving the carbonation packet by the carbonation chamber comprises:
receiving the carbonation packet through a carbonation source insertion inlet of the carbonation chamber.

Item 49: The method of any preceding item, wherein said receiving the volume of water comprises:
pumping the volume of water from a water reservoir to the carbonation chamber.

Item 50: The method of any preceding item, further comprising:
after said generating the carbon dioxide gas, removing liquid waste from the carbonation chamber through a byproduct outlet of the carbonation chamber.

Item 51: The method of any preceding item, further comprising:
directing the generated carbon dioxide gas along a fluid flow path into contact with a beverage in a beverage container.

Item 52: The method of any preceding item, further comprising:
recirculating the generated carbon dioxide gas that exits the beverage container along the fluid flow path and back into the beverage container.

Item 52: The method of any preceding item, wherein the volume of water received into the carbonation chamber is at least 50 mL.

Item 53: The method of any preceding item, wherein the volume of water received into the carbonation chamber is received through a carbonation chamber fluid inlet.

We claim:

1. A carbonation packet for depositing carbon dioxide generating material into a carbonation chamber of a beverage carbonator, the carbonation packet comprising:
a packet body defining a single compartment;
a granular carbonate material sealed within the single compartment, the granular carbonate material being water-dissolvable;
a granular acid material sealed within the single compartment, the granular acid material being water-dissolvable; and
a granular desiccant material sealed within the single compartment to prevent the granular carbonate material from reacting with the granular acid material while sealed in the single compartment, the granular desiccant material being water-dissolvable.

2. The carbonation packet of claim 1, wherein the granular desiccant material prevents the granular carbonate material from reacting with the granular acid material while sealed in the single compartment by absorbing moisture.

3. The carbonation packet of claim 1, wherein the granular desiccant material delays the granular carbonate material from reacting with the granular acid material until a water retention capacity of the granular desiccant material is surpassed.

4. The carbonation packet of claim 3, wherein, once the water retention capacity of the granular desiccant material is surpassed, the granular carbonate material is reactive with the granular acid material in water to generate carbon dioxide gas.

5. The carbonation packet of claim 1, wherein the granular carbonate material, the granular acid material, and the granular desiccant material are mixed within the single compartment.

6. The carbonation packet of claim 1, wherein the granular desiccant material comprises MgSO₄ (anhydrous).

7. The carbonation packet of claim 1, wherein the packet body is at least partially dissolvable in water to release the granular carbonate material, the granular acid material, and the granular desiccant material from the single compartment.

8. The carbonation packet of claim 1, wherein the single compartment is at least partially openable to release the granular carbonate material, the granular acid material, and the granular desiccant material therefrom.

9. A beverage carbonation system comprising:
a carbonation packet comprising:
a packet body defining a single compartment;
a granular carbonate material sealed within the single compartment, the granular carbonate material being water-dissolvable;
a granular acid material sealed within the single compartment, the granular acid material being water-dissolvable, the granular carbonate material being reactive with the granular acid material in water to generate carbon dioxide gas; and
a granular desiccant material sealed within the single compartment, the granular desiccant material being water-dissolvable, wherein the single compartment is at least partially openable to release the granular carbonate material, the granular acid material, and the granular desiccant material therefrom; and
a beverage carbonator comprising:
a carbonation chamber having a carbonation source inlet, a fluid inlet, a gas outlet, and a carbonation source carrier, the carbonation source carrier being positioned to receive the granular carbonate material, the granular acid material and the granular desiccant material deposited into the carbonation chamber through the carbonation source inlet, the carbonation source carrier and the fluid inlet being arranged to expose the granular carbonate material, the granular acid material and the granular desiccant material to water introduced into the carbonation chamber through the fluid inlet.

10. The beverage carbonation system of claim 9, wherein the granular desiccant material prevents the granular carbonate material from reacting with the granular acid material while sealed in the single compartment by absorbing moisture.

11. The beverage carbonation system of claim 9, wherein the granular desiccant material delays the granular carbonate material from reacting with the granular acid material until a water retention capacity of the granular desiccant material is surpassed.

12. The beverage carbonation system of claim 9, wherein the gas outlet provides an exit for carbon dioxide gas generated in the carbonation chamber.

13. The beverage carbonation system of claim 9, wherein the carbonation chamber comprises a byproduct outlet, the byproduct outlet being openable to provide an exit for a disposable liquid byproduct from the carbonation chamber.

14. The beverage carbonation system of claim 9, wherein the granular desiccant material comprises MgSO₄ (anhydrous).

15. A method of generating carbon dioxide gas for a beverage, the method comprising:
simultaneously receiving a granular carbonate material, a granular acid material and a granular desiccant material by a carbonation chamber;
receiving a volume of water into the carbonation chamber, the received volume of water exceeding a water retention capacity of the granular desiccant material; and
generating carbon dioxide gas from a reaction between at least the granular carbonate material and the granular acid material.

16. The method of claim 15, wherein said generating the carbon dioxide gas comprises:
mixing the granular carbonate material, the granular acid material, and the granular desiccant material with the volume of water received into the carbonation chamber.

17. The method of claim 15, wherein said simultaneously receiving comprises:
receiving a carbonation packet by the carbonation chamber, the carbonation packet having a dissolvable packet body that is flexible and rapidly water-dissolvable, the dissolvable packet body defining a single compartment that seals the granular carbonate material, the granular acid material, and the granular desiccant material.

18. The method of claim 17, further comprising:
at least partially dissolving the dissolvable packet body with the volume of water received into the carbonation chamber to release the granular carbonate material, the granular acid material, and the granular desiccant material from the single compartment.

19. The method of claim 15, further comprising:
after said generating the carbon dioxide gas, removing byproduct waste from the carbonation chamber through a byproduct outlet of the carbonation chamber.

20. The method of claim 15, further comprising:
directing the generated carbon dioxide gas along a fluid flow path into contact with a beverage in a beverage container.
